(19) United States
(12) Patent Application Publication
(10) Pub. No.: US 2020/0382466 A1
(43) Pub. Date: Dec. 3, 2020

(54) ENHANCED NEIGHBOR DISCOVERY FOR COMMUNICATION NETWORKS

(71) Applicant: CONVIDA WIRELESS, LLC, Wilmington, DE (US)

(72) Inventors: Quang LY, North Wales, PA (US); Chonggang WANG, Princeton, NJ (US); Rocco DI GIROLAMO, Laval (CA); Zhou CHEN, Claymont, DE (US); Vindo CHOYI, Conshohocken, PA (US); Shamin Akbar RAHMAN, Cote St. Luc (CA); Xu LI, Plainsboro, NJ (US)

(21) Appl. No.: 15/755,734

(22) PCT Filed: Sep. 2, 2016
(86) PCT No.: PCT/US2016/050104

§ 371 Date: Feb. 27, 2018

Related U.S. Application Data
(60) Provisional application No. 62/213,761, filed on Sep. 3, 2015.

(51) Int. Cl. H04L 29/12; H04L 12/24

(52) U.S. Cl. CPC H04L 61/2061; H04L 41/12

(57) ABSTRACT

The application is directed to an apparatus for allocating address space. The apparatus includes a non-transitory memory operably coupled to a processor configured to perform the step of locating a router on a network. The processor also performs the step of sending a router solicitation message including an address allocation flag to the router to reserve the address space. The processor also performs the step of receiving a router advertisement message based upon the router solicitation message including an address space option. Further, the processor performs the step of saving the address space provided in the router advertisement. The application is also directed to a computer-implemented apparatus for communicating address space between routers. The application is also directed to a computer-implemented apparatus for reallocating assigned IP address space. The application is also directed to an apparatus for registering a node with a router.

### CROSS-REFERENCE TO RELATED APPLICATIONS

This application claims priority to U.S. Provisional Application No. 62/213,761, filed Sep. 3, 2015, the disclosure of which is incorporated herein by reference in its entirety.

### FIELD

The present application is directed to enhanced protocols and systems for neighbor discovery in communication networks, such as the internet of things (IoT). More particularly, the application is directed to enhanced neighbor discovery protocols and architecture in large network deployments.

### BACKGROUND

IPv6 ND protocols were designed at a time where the use of link local multicast had the same reliability and network cost as unicast. Devices were therefore always on and connected.

More recently, network dynamics have changed to include the use of wireless networks and battery powered devices. As a result, these devices are not always on and connected. However, Duplicate Address Detection (DAD) or DHCPv6 messages are still needed to verify that the addresses are unique within the local link.

Past improvements primarily focused on the end node to router interface. In operation, 6LoWPANs can support a large number of nodes (e.g., 5,000) connected over a large number of LLN hops (e.g. >15). These protocols are centralized around a border router or a DHCPv6 server. As a result, a large amount of control traffic is introduced by neighbor discovery protocols when deploying multiple hops for plural nodes in the network. For each hop in the network, a pair of DAR/DAC or Request/Reply messages is required. If DAD detects a duplicate address, the process is repeated for the new address. This process leads to high messaging overhead as well as increased latency when performing DAD or DHCPv6 over a large number of hops.

### SUMMARY

This summary is provided to introduce a selection of concepts in a simplified form that is further described below in the Detailed Description. This Summary is not intended to limit the scope of the claimed subject matter. The foregoing needs are met, to a great extent, by the present application directed.

In one aspect of the application, there is described computer-implemented apparatus, and a computer-implemented method, for allocating address space. The apparatus includes a non-transitory memory having instructions stored thereon for allocating address space. The apparatus also includes a processor, operably coupled to the non-transitory memory. The processor is configured to perform the step of locating a router on a network. The processor is also configured to perform the step of sending a router solicitation message including an address allocation flag to the router to reserve the address space. The processor is also configured to perform the step of receiving a router advertisement message based upon the router solicitation message including an address space option. Further, the processor is configured to perform the step of saving the address space provided in the router advertisement.

In another aspect of the application, there is described a computer-implemented apparatus, and a computer-implemented method, for communicating address space between routers. The apparatus includes a non-transitory memory having instructions stored thereon for communicating address space between routers. The apparatus also includes a processor, operably coupled to the non-transitory memory. The processor is configured to perform the step of receiving a message including an address space option from another router. The processor is configured to also perform the step of saving information from the router including an IP address and the address space option in the memory. The processor is further configured to perform the step of sending a message including the address space option to another router.

In yet another aspect of the application, there is described a computer-implemented apparatus, and a computer-implemented method, for reallocating assigned IP address space. The apparatus includes a non-transitory memory having instructions stored thereon for reallocating assigned IP address space. The apparatus also includes a processor, operably coupled to the non-transitory memory. The processor is configured to perform the step of receiving an update advertisement message from a router including an address space option including a range of previously allocated address space. The processor is also configured to perform the step of checking the memory to see if an address meets the range specified in the address space option. The processor is also configured to perform the step of sending an acknowledgment message to the router with information about repatriating the range of previously allocated address space.

In a further aspect, there is described a computer-implemented apparatus, and a computer-implemented method, for registering a node with a router. The apparatus includes a non-transitory memory having instructions stored thereon for registering a node with a router. The apparatus also includes a processor, operably coupled to the non-transitory memory. The processor is configured to perform the step of receiving, from a node, a message with an address request. The processor is configured to perform the step of assigning an address to the node using an address allocation option. The processor is also configured to perform the step of sending, to the node, a message including an address registration option and an address allocation option. The processor is further configured to perform the step of receiving, from the node, an acknowledgment including the address registration option and the address allocation option.

There has thus been outlined, rather broadly, certain embodiments of the invention in order that the detailed description thereof may be better understood, and in order that the present contribution to the art may be better appreciated.

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1 illustrates an overview of the IPv6 Neighbor Discovery according to an embodiment of the application.

FIG. 2 illustrates an overview of 6LoWPAN Network according to an embodiment of the application.

FIG. 3 illustrates an overview of 6LoWPAN Neighbor Discovery according to an embodiment of the application.

FIG. 4 illustrates an overview of efficient Neighbor Discovery according to an embodiment of the application.

FIG. 5 illustrates an overview of DHCPv6 according to an embodiment of the application.

FIG. 6A illustrates a machine-to machine (M2M) or IoT communication system according to an embodiment of the application.

FIG. 6B illustrates the application of a M2M service platform according to an embodiment of the application.

FIG. 6C illustrates the application of a system diagram of an example M2M device according to an embodiment of the application.

FIG. 6D illustrates the application of a block diagram of an exemplary computing system according to an embodiment of the application.

FIG. 7 illustrates a call flow for a 6LoWPAN Border Router (6LBR) to disseminate address spaces to 6LRs according to an embodiment of the application.

FIG. 8 illustrates a call flow for a 6LR to disseminate address space information to neighbor routers according to another embodiment according to an embodiment of the application.

FIG. 9 illustrates a call flow for a 6LBR to repatriate address space from 6LR according to an embodiment of the application.

FIG. 10 illustrates call flows for streamlined Neighbor Discovery (ND) according to an embodiment of the application.

FIG. 11 illustrates call flows streamlined ND address registration according to an embodiment of the application.

FIG. 12 illustrates a call flow for address registration to multiple routers using NS messages according to an embodiment of the application.

FIG. 13 illustrates a call flow for address registration to multiple routers using RS messages with a Registration Token Option (RTO) according to an embodiment of the application.

FIG. 14 illustrates a call flow for multiple address registration using RS messages with no RTO according to an embodiment of the application.

FIG. 15 illustrates a call flow for support of 6LN mobility using NS messages according to an embodiment of the application.

FIG. 16A illustrates a state diagram for address registration using RS messages according to an embodiment of the application.

FIG. 16B illustrates a state diagram for address registration using NS messages according to an embodiment of the application.

FIG. 17 illustrates a graphical user interface according to another embodiment of the application.

FIG. 18 illustrates a router solicitation message according to an embodiment of the application.

FIG. 19 illustrates a router advertisement message according to an embodiment of the application.

FIG. 20 illustrates a neighbor solicitation message according to an embodiment of the application.

FIG. 21 illustrates a neighbor advertisement message according to an embodiment of the application.

FIG. 22 illustrates an update advertisement message according to an embodiment of the application.

FIG. 23 illustrates an update acknowledgment message according to an embodiment of the application.

FIG. 24 illustrates a router acknowledge message according to an embodiment of the application.

FIG. 25 illustrates a multiple registration advertisement message according to an embodiment of the application.

### DETAILED DESCRIPTION OF THE ILLUSTRATIVE EMBODIMENTS

A detailed description of the illustrative embodiment will be discussed in reference to various figures, embodiments and aspects herein. Although this description provides detailed examples of possible implementations, it should be understood that the details are intended to be examples and thus do not limit the scope of the application.

Reference in this specification to “one embodiment,” “an embodiment,” “one or more embodiments,” “an aspect” or the like means that a particular feature, structure, or characteristic described in connection with the embodiment is included in at least one embodiment of the disclosure. Moreover, the term “embodiment” in various places in the specification is not necessarily referring to the same embodiment. That is, various features are described which may be exhibited by some embodiments and not by the other.

Generally, the application is directed to neighbor discovery (ND) procedures in a large network. In particular, the enhancements are directed to both 6LoWPAN ND and Efficient ND to address the issue of scalability in large network deployments. This application aims to minimize the overhead of multi-hop ND DAD by enabling 6LRs to assign unique global IP addresses without needing to consult the 6LBR for DAD. Each 6LR is allocated an address space within the 6LoWPAN by the 6LBR with which to assign address during 6LN registration. In addition, the 6LRs can communicate with each other in their allocated address space to aid in mobility cases. 6LNs can then request an address from the 6LR by setting an appropriate flag in an RS or NS message. The 6LR assigns an address within its allocated range and may also support multiple registrations of the 6LN to neighbor routers.

According to the application, the address registration request may be performed using either an RS or NS message. In either case, the requesting node is assigned an address. The RS and NS messages are independent of each other and each may be implemented without the other to support address registration. The NS and RS messages may provide optimizations and messaging reduction, and can be employed with existing functionality in a mixed mode configuration similar to how “Efficient ND” works with original ND.

According to one aspect of the application, architecture and protocols are described to support address space allocation to routers. This feature provides 6LBR the ability to allocate address space to 6LRs so that each 6LR may determine the global IP addresses it can assign to end nodes, i.e., 6LNs. This distributes the address resolution to 6LRs instead of 6LBR and is used as part of the streamlined address registration procedure. In addition, 6LRs can communicate its own address space to other routers to support mobility.

According to another aspect of the application, architecture and protocols are described to streamline ND address registration. This may be performed without DAD. By employing the allocated address space provisioned to 6LRs, 6LNs can request an address as part of router discovery. Accordingly, performing DAD is not necessary because 6LRs have the capability to assign addresses in its space. In an embodiment, 6LNs may request address assignments using existing NS message with new message flags and option.

According to yet another aspect of the application, architecture and protocols are described to support address registrations to multiple routers. 6LNs can request an address from a registrar 6LR. 6LNs can also indicate they are interested in having the registrar 6LR extend the registration to neighbor 6LRs. Specifically, the registrar 6LR provides the same address assignment to the neighbor 6LRs that it provides to the 6LN. As a result, the 6LN is registered to multiple 6LRs with the same address to provide for redundant routing options.

According to yet even another aspect of the application, architecture and protocols are described to support multiple address registrations to different routers. 6LNs can multicast RS messages with new options to register to multiple 6LRs. Here, 6LNs are assigned different addresses from the different routers.

According to a further aspect of the application, architecture and protocols are described to support node mobility within the local link. Namely, routers can query each other to check on a node's registration. Since routers share address space allocations with each other, the registrar router knows which neighbor router to contact to support this procedure.

### Definitions and Acronyms

Table 1 below provides definitions for terms and phrases commonly used throughout this application. For example, a host is any node that is not a router. An interface is a node's attachment to the link. A link is a medium where nodes can communicate with each other at the link layer of the network stack, e.g., Ethernet. A link-layer identifier for an interface is the MAC address of an Ethernet network. A link-local address has a link-only scope that can be used to reach neighboring nodes on the same link. A neighbor is a node that is attached to the same link. A node is a device that implements Internet protocol (IP). Further, a prefix is the initial bits of an IPv6 address. A router is a node that forwards IP packets not explicitly addressed to itself

The service layer may be a functional layer within a network service architecture. Service layers are typically situated above the application protocol layer such as HTTP, CoAP or MQTT and provide value added services to client applications. The service layer also provides an interface to core networks at a lower resource layer, such as for example, a control layer and transport/access layer. The service layer supports multiple categories of (service) capabilities or functionalities including service definition, service runtime enablement, policy management, access control, and service clustering. Recently, several industry standards bodies, e.g., oneM2M, have been developing M2M service layers to address the challenges associated with the integration of M2M types of devices and applications into deployments such as the Internet/Web, cellular, enterprise, and home networks. A M2M service layer can provide applications and/or various devices with access to a collection of or a set of the above mentioned capabilities or functionalities, supported by the service layer, which can be referred to as a common service entity (C SE) or a service capability layer (SCL). A few examples include but are not limited to security, charging, data management, device management, discovery, provisioning, and connectivity management which can be commonly used by various applications. These capabilities or functionalities are made available to such various applications via APIs which make use of message formats, resource structures and resource representations defined by the M2M service layer. The CSE or SCL is a functional entity that may be implemented by hardware and/or software and that provides (service) capabilities or functionalities exposed to various applications and/or devices (i.e., functional interfaces between such functional entities) in order for them to use such capabilities or functionalities.

TABLE 1

| Acronym | Term or Phrase |
|---|---|
| 6CO | 6LoWPAN Context Option |
| 6LBR | 6LoWPAN Border Router |
| 6LN | 6LoWPAN Node |
| 6LoWPAN | IPv6 over Low-power Wireless Personal Area Networks |
| 6LR | 6LoWPAN Router |
| AA | Address Allocation (flag) |
| AAO | Address Allocation Option |
| ABRO | Authoritative Border Router Option |
| AMR | Automatic Meter Readers |
| AR | Address Request (flag) |
| ARO | Address Registration Options |
| ASO | Address Space Option |
| CID | DHCPv6 Client Identifier |
| CoAP | Constrained Application Protocol |
| DAC | Duplicate Address Confirmation |
| DAD | Duplicate Address Detection |
| DAR | Duplicate Address Request |
| DHCPv6 | Dynamic Host Configuration Protocol for IPv6 |
| EAH | Efficiency-Aware Host |
| EUI | (IEEE) Extended Unique Identifier |
| IA | Identity Association |
| ICMP | Internet Control Message Protocol |
| IPv6 | Internet Protocol version 6 |
| LLN | Low-power, lossy networks |
| MR | Multiple Registration (flag) |
| MRA | Multiple Registration Advertisement |
| MTU | Maximum Transmission Unit |
| NA | Neighbor Advertisement |
| ND | Neighbor Discovery |
| NEAR | IPv6 ND-efficiency-aware Router |
| NS | Neighbor Solicitation |
| NUD | Neighbor Unreachability Detection |
| PIO | Prefix Information Option |
| RA | Router Advertisement |
| RACK | Router Acknowledgement |
| RAO | Router Address Option |
| RS | Router Solicitation |
| RTO | Registration Token Option |
| SID | (DHCPv6) Server Identifier |
| SLAAC | Stateless Address Auto-Configuration |
| SLLAO | Source Link-Layer Address Option |
| TID | Transaction Identifier |
| UA | Update Advertisement |
| UACK | Update Acknowledgment |
| UIID | Unique Interface Identifier |

### IPv6 ND Protocols

The original IPv6 ND protocol was defined to let hosts and routers determine link-layer addresses of their neighbors. It also allows hosts to find nearby routers that will forward packets, and to detect the reachability of neighbors. The ND protocols also provide the mechanisms for stateless address auto-configuration and DAD. The combination of these two protocols will be referred to as the original ND protocol in this application. The ND protocol focuses on the interactions between hosts attached on the same link. One of the primary functionalities of these interactions is for hosts to discover nearby neighbors and routers. A secondary functionality is for hosts to configure their own address in a stateless manner.

The router discovery process is achieved through an ICMP message pair of a RS and a RA. Periodically, network routers multicast RA messages including information about the network, including but not limited to, network prefixes, hop limit, and link MTU. In addition, flags are included in the RA to inform hosts how to perform address auto-configuration. This can be done through DHCPv6 or a stateless address auto-configuration (SLAAC). These RA messages allow hosts to build a list of default routers fairly quickly. Hosts may also immediately request unicast RA messages by sending RS messages if they do not want to wait for the periodic RA messages.

Similarly, hosts can discover neighbors through a pair of ICMP messages including NS and NA. NS messages are sent when hosts want to determine the link-layer address of its neighbors and also to perform address resolution. Similar to RS messages, NS messages include the target address used for DAD and are multicast to the nodes in the network. If a node within the network is using the target address found in the NS message, a NA message is returned to the soliciting host during DAD to signal that the address is not unique. If a NA message is not returned, then the target address is unique and can be used by the host.

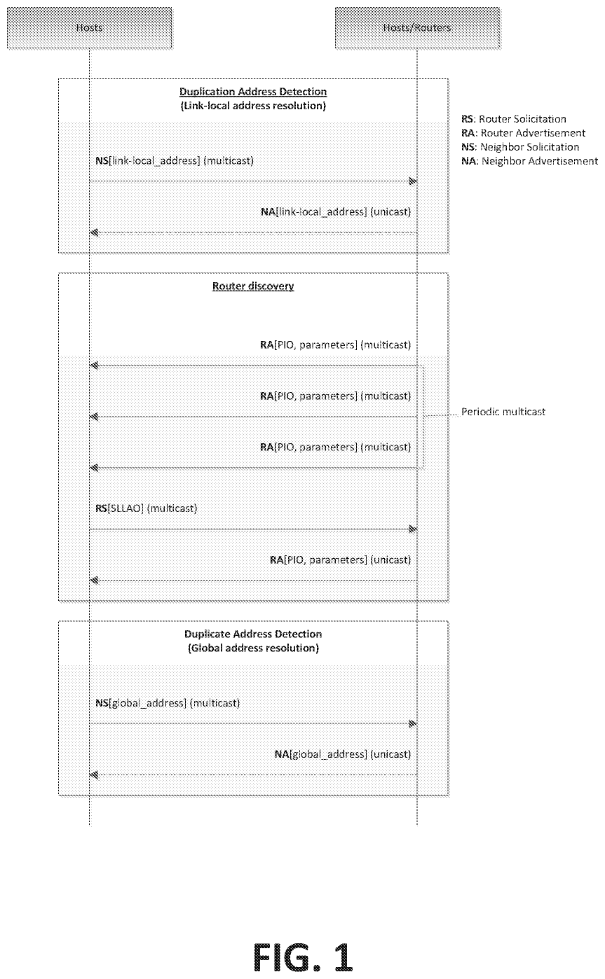

FIG. 1 depicts the protocol overview of the steps a host goes through to auto-configure itself A link-local address is generated from combining the link-local prefix with the host's interface identifier and the resulting address is sent in an NS message. This message is multicast to the nodes in the link to perform DAD. If no NA message is returned, then the host is free to use the link-local address and assign it to its interface. At this point, the host has IP connectivity with its neighbors. If a NA message is returned, then the address is not unique and the host has to configure a new link-local address by manual configuration or some other mechanism.

After the host has obtained its link-local address, it performs router discovery to find all of its neighbor routers. It can send a RS message to quickly obtain the RA response from nearby routers. Alternatively, the host may wait for the periodic RA messages that routers send. The RA messages contain important parameters about network configurations including but not limited to Prefix Information Options (PIO), MTU value, address configuration M and O flags. The PIO parameters provide hosts with information for generating a global address using the given prefix, and the M and O flags indicate whether DHCPv6 should be used to configure the host's address.

Once the host has received the parameters within the RA message, it can then proceed to obtain a global address. If DHCPv6 is configured, it requests a global address from the DHCPv6 server. Otherwise, the host configures its global address using the PIO parameter and performs DAD on the generated address to ensure it is unique. While the procedure outlined in FIG. 1 shows the DAD of link-local address resolution occurs before router discovery, it may be performed in any order. The global address resolution occurs after router discovery and depends on information in the RA message.

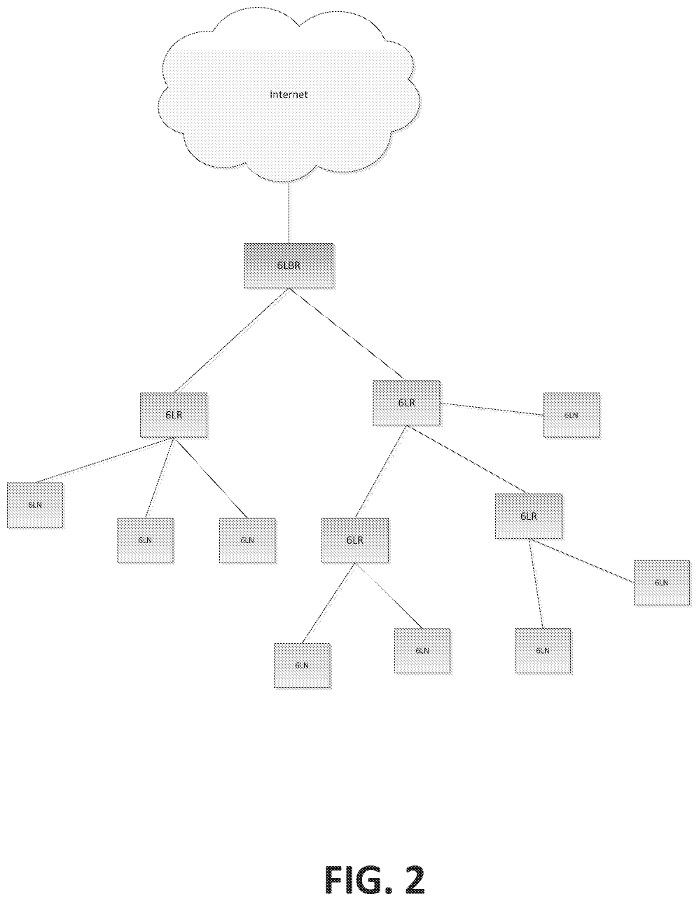

IPv6 over 6LoWPANs are characterized by devices that operate in short range, low bit rate, low power, and low cost. The devices conform to the IEEE 802.15.4 standard and are typically constrained in nature. As illustrated in FIG. 2, 6LoWPAN networks consist of Border Routers (6LBR), Routers (6LR) and Nodes (6LN). The network could be deployed as an isolated network or a network integrated with the Internet. The links within the network may be unreliable and nodes may be sleeping for long periods of time. Various applications of these networks include but are not limited to industrial and office automation, connected homes, agriculture, and smart meters and may be viewed and operated by a user via a graphical user interface (GUI).

IETF RFC 6775 provides an optimized ND protocol for use in 6LoWPAN networks. This protocol addresses issues encountered with original ND operating in 6LoWPAN networks. The need for multicast NS and periodic RA messages between host and routers are replaced with host-initiated unicast messages. As a result, multicast-based address resolution is replaced with host initiated unicast address registration and a new multi-hop DAD procedure. These optimizations help with sleepy nodes within the network by freeing them of the burden to defend their address during multicast DAD in original ND.

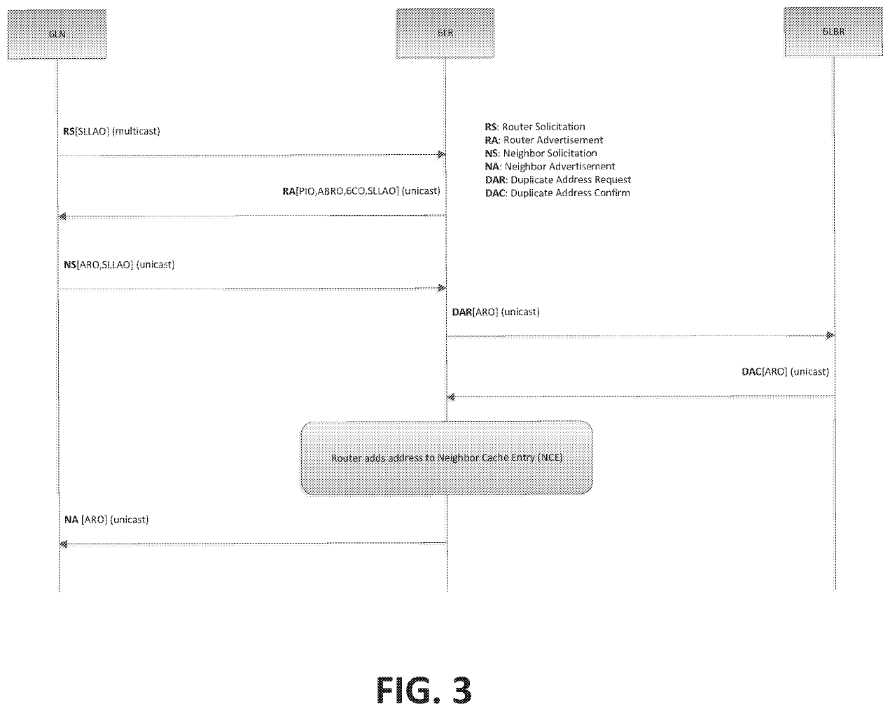

FIG. 3 shows a general overview of the optimized ND for 6LoWPAN. The link-local address is constructed by the 6LN based on a unique EUI-64 identifier assigned to the 6LoWPAN interface as per IETF RFC 4944. This is performed internally and does not require DAD since the EUI-64 is unique within the 6LoWPAN. Then, 6LN performs router discovery to obtain a list of default routers by sending an RS message. This message is multicast to all routers with the Source Link-Layer Address Option (SLLAO) so routers can use it to reply with a unicast RA. The SLLAO is the link-layer address of the 6LN. If neighbor routers are available, they will reply with an RA message that includes various options describing the network such as PIO, Authoritative Border Router Option (ABRO), and 6LoWPAN Context Option (6C0). The RA message also contains flags to indicate how address is to be configured and triggers the address registration procedure that follows.

The 6LN initiates the global address registration procedure by sending a unicast NS message that includes both Address Registration Option (ARO) and SLLAO options. Since this is the first time the address is registered, the 6LR performs DAD with the 6LBR to ensure the global address is unique. The DAD procedure consists of sending a DAR message from the 6LR to the 6LBR, which maintains the master list of global addresses within the 6LoWPAN. This DAR message contains information from the ARO option and may pass through multiple hops before reaching the 6LBR. Once the 6LBR confirms the address is unique, it sends a DAC message back to the original 6LR indicating whether the address is unique and can be registered. If the address is unique, the 6LR adds the address to its NCE and classifies it as a Registered NCE with an appropriate lifetime before the registration expires. A NA message is returned to the 6LN indicating the status of the registration request with the ARO option.

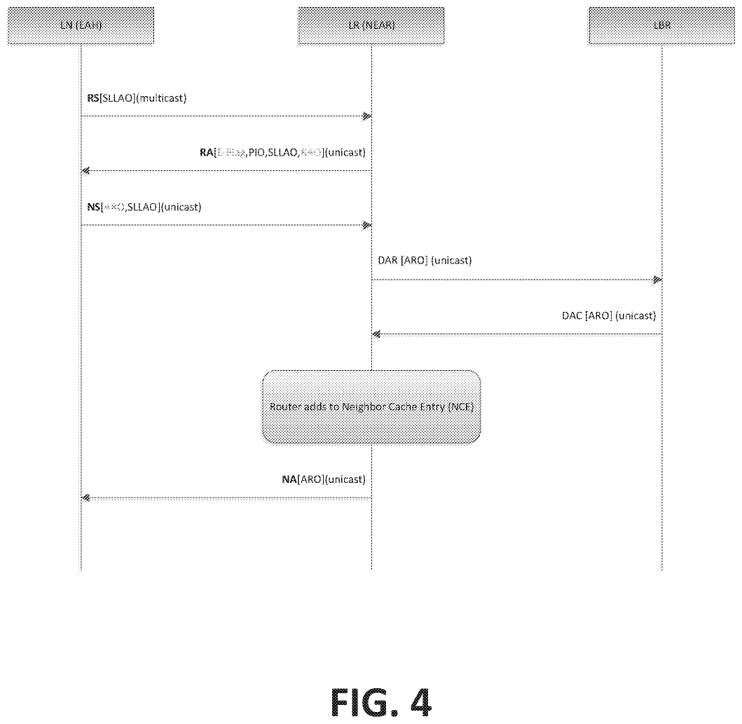

FIG. 4 illustrates an overview of the characteristics of the Efficient ND network as described in “draft-chakrabarti-nordmark-6man-efficient-nd-07.” Compared to “Original ND,” “Efficient ND” removes both multicast NS and RA messages but retains the use of multicast RS messages similar to 6LoWPAN ND. In Efficient ND, two new parameters are added to the RA message: an “E” flag to indicate if an IPv6 ND-efficiency-aware Router (NEAR) is present and the RAO option, which specifies the Registrar Address Option. This option provides a list of NEAR routers within the network with which Efficiency-Aware Host (EAH) registers its address to. In addition, a Router Epoch is provided to signal to EAHs to re-register when a NEAR experiences a state loss. This parameter allows NEARs to minimize the need to store its NCE state by having the EAHs re-register. The inclusion of the “E” flag allows Efficient ND to co-exist with original ND in a mixed mode configuration. If a router does not include the flag, then operation defaults to original ND.

Once an EAH receives the new RA message, it needs to register its addresses with all the NEARs provided in the RAO. An NS message is unicast to the NEAR with an ARO option introduced in IETF RFC 4944 that has been extended to support different unique identifiers other than EUI-64, such as DHCP Unique Identifier (DUID). A Transaction ID is also added to help NEARs distinguish current vs older registrations due to packet loss. Once a NEAR receives an address registration request from an EAH, it performs DAD using the procedures outlined in above.

The call flows of FIGS. 3 and 4 are similar and are the result of trying to solve the problems presented in modern wireless networks. 6LoWPAN ND optimizes the original ND for 6LoWPAN links while Efficient ND optimizes original ND for networks of any link type. They both address the lossy nature of wireless networks due to dropped packets and both also support sleeping nodes by removing multicast DAD.

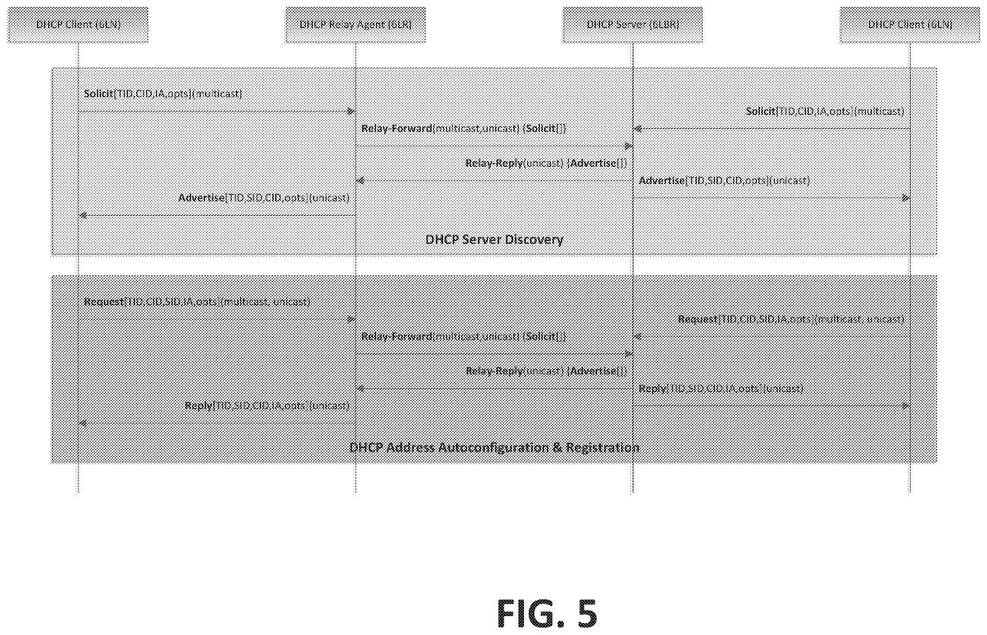

DHCPv6 provides for stateful address auto-configuration in which a DHCPv6 server assigns a global IP address to clients upon request. FIG. 5 illustrates an overview of the message exchange between client and server. A Solicit message is multicast by the DHCPv6 client to discover DHCPv6 servers on the link. Within the message, a Transaction ID (TID), a Client ID (CID), an Identity Association (IA), and other options the client is requesting from the server. The CID is a unique identifier the DHCPv6 server uses to identify the client while the IA is an identifier used to associate to the client's interface. The Solicit message must be sent with the client's link-local address as the source address in the IP header.

Upon receiving the Solicit message, the DHCPv6 server prepares an Advertise message to return to the client. It copies the TID and CID from the Solicit message to be included in the Advertise message and adds its own Server ID (SID) as well. Based on the options presented in the Solicit message, the server will return configuration parameters if the requested option is supported. It may also add options of its own to indicate to the client what parameters will be returned in a subsequent Reply message. The Advertise message is returned to the client's link-local address if it was received directly from the client or to the Relay Agent to forward to the client.

A client may receive advertise messages from several DHCPv6 servers and based on the options returned will pick a server for the Request message. In this message, the client adds the SID in addition to the TID, CID, IA, and options for the request. The client will multicast this message to the server unless the server has included a Server Unicast Option in the Advertise message.

When a DHCPv6 server receives a valid request message, it creates a binding for the client's IA and assigns an address to it along with other configuration parameters. It then constructs a Reply message with TID, SID, CID, IA, and options to the client. At this point, the server is committing the use of the provided address to the client for the registration lifetime configured by the administrator. Subsequently, the client should perform DAD after receiving the Reply message to ensure it is unique.

### General Architecture

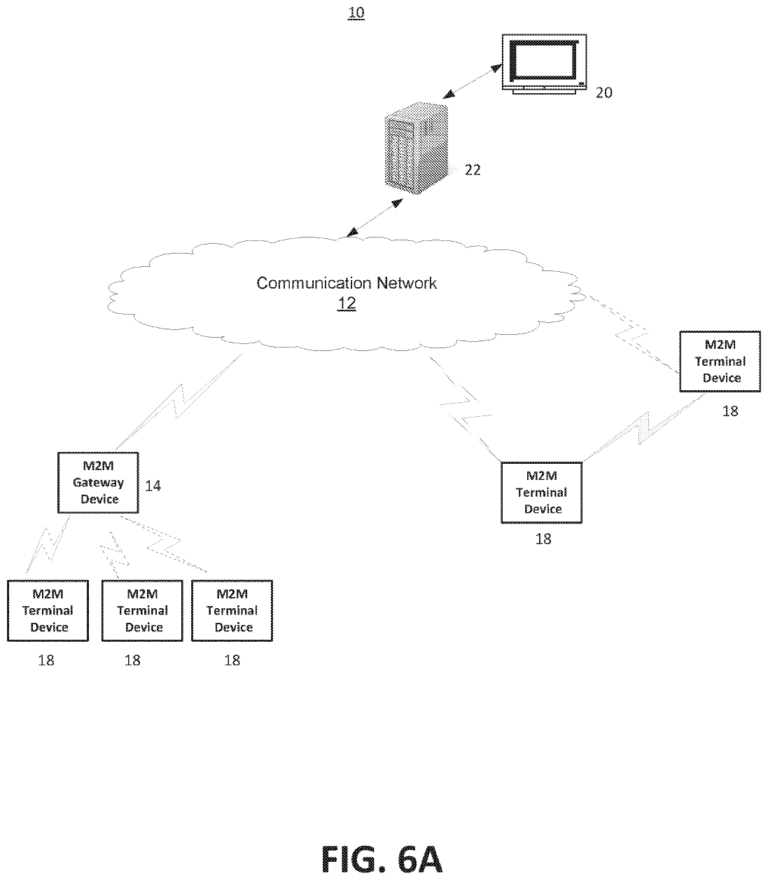

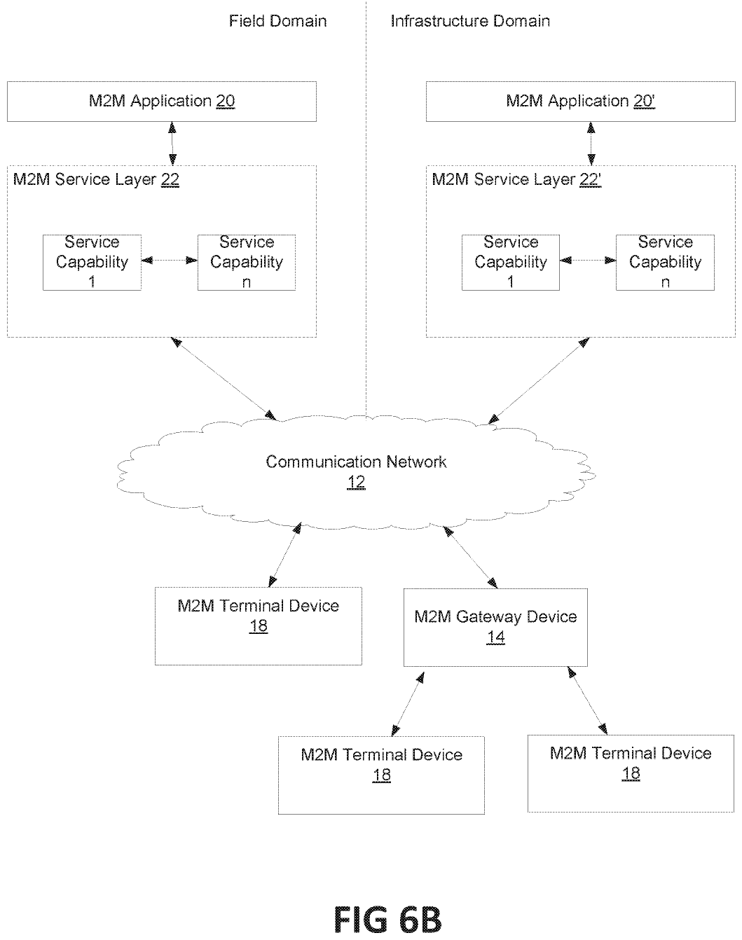

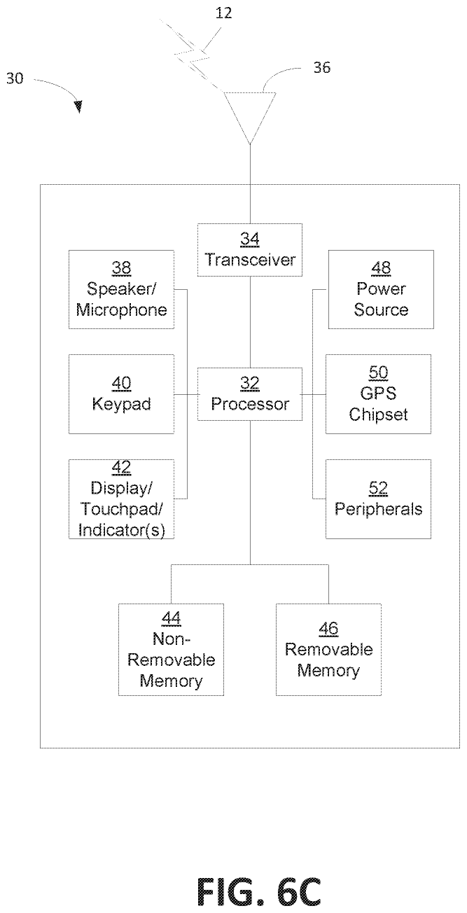

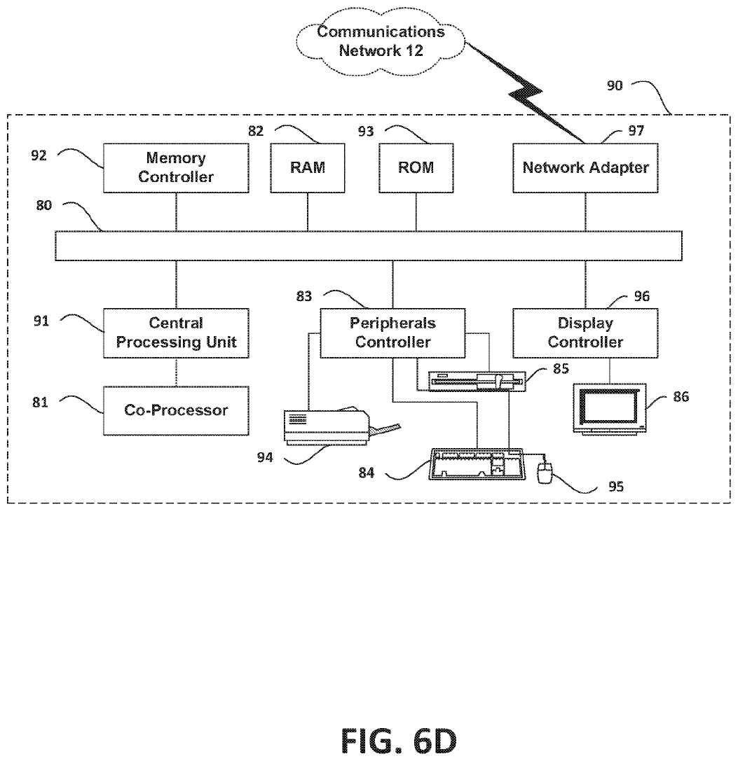

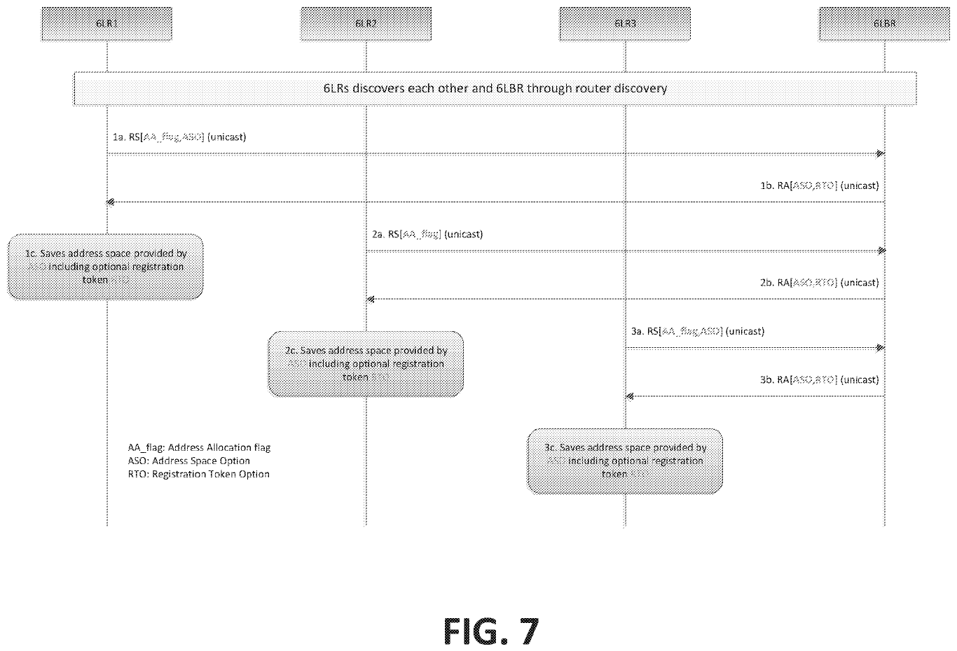

FIG. 6A is a diagram of an example machine-to machine (M2M), Internet of Things (IoT), or Web of Things (WoT) communication system 10 in which one or more disclosed embodiments may be implemented. Generally, M2M technologies provide building blocks for the IoT/WoT, and any M2M device, M2M gateway, M2M server, or M2M service platform may be a component or node of the IoT/WoT as well as an IoT/WoT service layer, etc. Any of the devices referred to in any of FIGS. 7-15 may comprise a node of a communication system such as the one illustrated in FIGS. 6A-D.

As shown in FIG. 6A, the M2M/IoT/WoT communication system 10 includes a communication network 12. The communication network 12 may be a fixed network (e.g., Ethernet, Fiber, ISDN, PLC, or the like) or a wireless network (e.g., WLAN, cellular, or the like) or a network of heterogeneous networks. For example, the communication network 12 may be comprised of multiple access networks that provide content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 6A, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain and Infrastructure Domain may both comprise a variety of different nodes (e.g., servers, gateways, device, and the like) of the network. For example, the Field Domain may include M2M gateways 14 and devices 18. It will be appreciated that any number of M2M gateway devices 14 and M2M devices 18 may be included in the M2M/IoT/WoT communication system 10 as desired. Each of the M2M gateway devices 14 and M2M devices 18 are configured to transmit and receive signals, using communications circuitry, via the communication network 12 or direct radio link. A M2M gateway 14 allows wireless M2M devices (e.g. cellular and non-cellular) as well as fixed network M2M devices (e.g., PLC) to communicate either through operator networks, such as the communication network 12 or direct radio link. For example, the M2M devices 18 may collect data and send the data, via the communication network 12 or direct radio link, to an M2M application 20 or other M2M devices 18. The M2M devices 18 may also receive data from the M2M application 20 or an M2M device 18. Further, data and signals may be sent to and received from the M2M application 20 via an M2M service layer 22, as described below. M2M devices 18 and gateways 14 may communicate via various networks including, cellular, WLAN, WPAN (e.g., Zigbee, 6LoWPAN, Bluetooth), direct radio link, and wireline for example. Exemplary M2M devices include, but are not limited to, tablets, smart phones, medical devices, temperature and weather monitors, connected cars, smart meters, game consoles, personal digital assistants, health and fitness monitors, lights, thermostats, appliances, garage doors and other actuator-based devices, security devices, and smart outlets.

Referring to FIG. 6B, the illustrated M2M service layer 22 in the field domain provides services for the M2M application 20, M2M gateways 14, and M2M devices 18 and the communication network 12. It will be understood that the M2M service layer 22 may communicate with any number of M2M applications, M2M gateways 14, M2M devices 18, and communication networks 12 as desired. The M2M service layer 22 may be implemented by one or more nodes of the network, which may comprises servers, computers, devices, or the like. The M2M service layer 22 provides service capabilities that apply to M2M devices 18, M2M gateways 14, and M2M applications 20. The functions of the M2M service layer 22 may be implemented in a variety of ways, for example as a web server, in the cellular core network, in the cloud, etc.

Similar to the illustrated M2M service layer 22, there is the M2M service layer 22′ in the Infrastructure Domain. M2M service layer 22′ provides services for the M2M application 20′ and the underlying communication network 12′ in the infrastructure domain. M2M service layer 22′ also provides services for the M2M gateways 14 and M2M devices 18 in the field domain. It will be understood that the M2M service layer 22′ may communicate with any number of M2M applications, M2M gateways and M2M devices. The M2M service layer 22′ may interact with a service layer by a different service provider. The M2M service layer 22′ may be implemented by one or more nodes of the network, which may comprises servers, computers, devices, virtual machines (e.g., cloud computing/storage farms, etc.) or the like.

Referring also to FIG. 6B, the M2M service layers 22 and 22′ provide a core set of service delivery capabilities that diverse applications and verticals can leverage. These service capabilities enable M2M applications 20 and 20′ to interact with devices and perform functions such as data collection, data analysis, device management, security, billing, service/device discovery etc. Essentially, these service capabilities free the applications of the burden of implementing these functionalities, thus simplifying application development and reducing cost and time to market. The service layers 22 and 22′ also enable M2M applications 20 and 20′ to communicate through various networks 12 and 12′ in connection with the services that the service layers 22 and 22′ provide.

The M2M applications 20 and 20′ may include applications in various industries such as, without limitation, transportation, health and wellness, connected home, energy management, asset tracking, and security and surveillance. As mentioned above, the M2M service layer, running across the devices, gateways, servers and other nodes of the system, supports functions such as, for example, data collection, device management, security, billing, location tracking/geofencing, device/service discovery, and legacy systems integration, and provides these functions as services to the M2M applications 20 and 20′.

Generally, a service layer, such as the service layers 22 and 22′ illustrated in FIGS. 6A and 6B, may be a functional layer within a network service architecture. Service layers are typically situated above the application protocol layer such as HTTP, CoAP or MQTT and provide value added services to client applications. The service layer also provides an interface to core networks at a lower resource layer, such as for example, a control layer and transport/access layer. The service layer supports multiple categories of (service) capabilities or functionalities including a service definition, service runtime enablement, policy management, access control, and service clustering. Recently, several industry standards bodies, e.g., oneM2M, have been developing M2M service layers to address the challenges associated with the integration of M2M types of devices and applications into deployments such as the Internet/Web, cellular, enterprise, and home networks. A M2M service layer can provide applications and/or various devices with access to a collection of or a set of the above mentioned capabilities or functionalities, supported by the service layer, which can be referred to as a Common Services Entity (CSE) or Service Capability Layer (SCL). A few examples include but are not limited to security, charging, data management, device management, discovery, provisioning, and connectivity management which can be commonly used by various applications. These capabilities or functionalities are made available to such various applications via APIs which make use of message formats, resource structures and resource representations defined by the M2M service layer. The CSE or SCL is a functional entity that may be implemented by hardware and/or software and that provides (service) capabilities or functionalities exposed to various applications and/or devices (i.e., functional interfaces between such functional entities) in order for them to use such capabilities or functionalities. The Third Generation Partnership Project (3GPP) has also defined an architecture for machine-type communications (MTC). In that architecture, the service layer, and the service capabilities it provides, are implemented as part of a Service Capability Server (SCS). Whether embodied in a device SCL (“DSCL”), gateway SCL (“GSCL”), or network SCL (“NSCL”) of the ETSI M2M architecture, in a Service Capability Server (SCS) of the 3GPP MTC architecture, in a Common Service Function (“CSF”) or CSE of the oneM2M architecture, or in some other node of a network, an instance of the service layer may be implemented as a logical entity (e.g., software, computer-executable instructions, and the like) executing either on one or more standalone nodes in the network, including servers, computers, and other computing devices or nodes, or as part of one or more existing nodes. As an example, an instance of a service layer or component thereof may be implemented in the form of software running on a network node (e.g., server, computer, gateway, device or the like) having the general architecture illustrated in FIG. 6C or FIG. 6D described below.

Further, the methods and functionalities described herein may be implemented as part of an M2M network that uses a Service Oriented Architecture (SOA) and/or a Resource-Oriented Architecture (ROA) to access services.

FIG. 6C is a block diagram of an example hardware/software architecture of a node of a network, such as one of the routers performing steps in any of FIGS. 7-15 which may operate as an M2M server, gateway, device, or other node in an M2M network such as that illustrated in FIGS. 6A and 6B. As shown in FIG. 6C, the node 30 may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The node 30 may also include communication circuitry, such as a transceiver 34 and a transmit/receive element 36. It will be appreciated that the node 30 may include any sub-combination of the foregoing elements while remaining consistent with an embodiment. This node may be a node that implements the time flexibility functionality described herein.

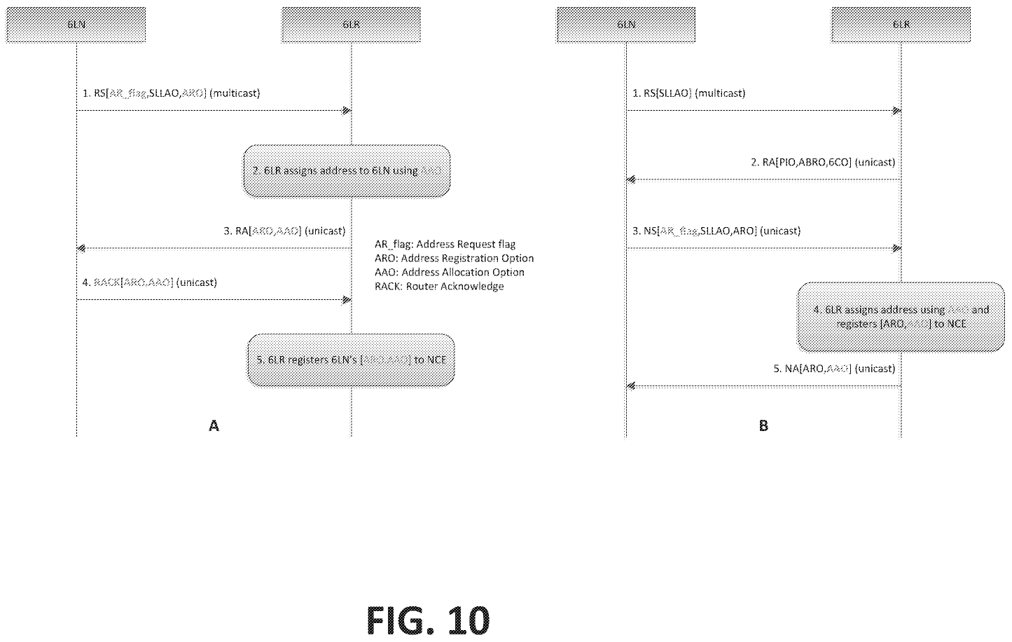

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node in order to perform the various required functions of the node. For example, the processor 32 may perform signal coding, data processing, power control, input/output processing, and/or any other functionality that enables the node 30 to operate in a wireless or wired environment. The computer executable instructions stored in the memory of the node, and executed by the processor, may further cause the node to perform the operations illustrated in FIG. 10 described above. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

As shown in FIG. 6C, the processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected. In particular, the processor 32 may control the communication circuitry in order to perform the described and illustrated herein (e.g., in FIGS. 7-15) and in the claims. While FIG. 6C depicts the processor 32 and the transceiver 34 as separate components, it will be appreciated that the processor 32 and the transceiver 34 may be integrated together in an electronic package or chip.

The transmit/receive element 36 may be configured to transmit signals to, or receive signals from, other nodes, including M2M servers, gateways, device, and the like. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 6C as a single element, the node 30 may include any number of transmit/receive elements 36. More specifically, the node 30 may employ MIMO technology. Thus, in an embodiment, the node 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple RATs, such as UTRA and IEEE 802.11, for example.

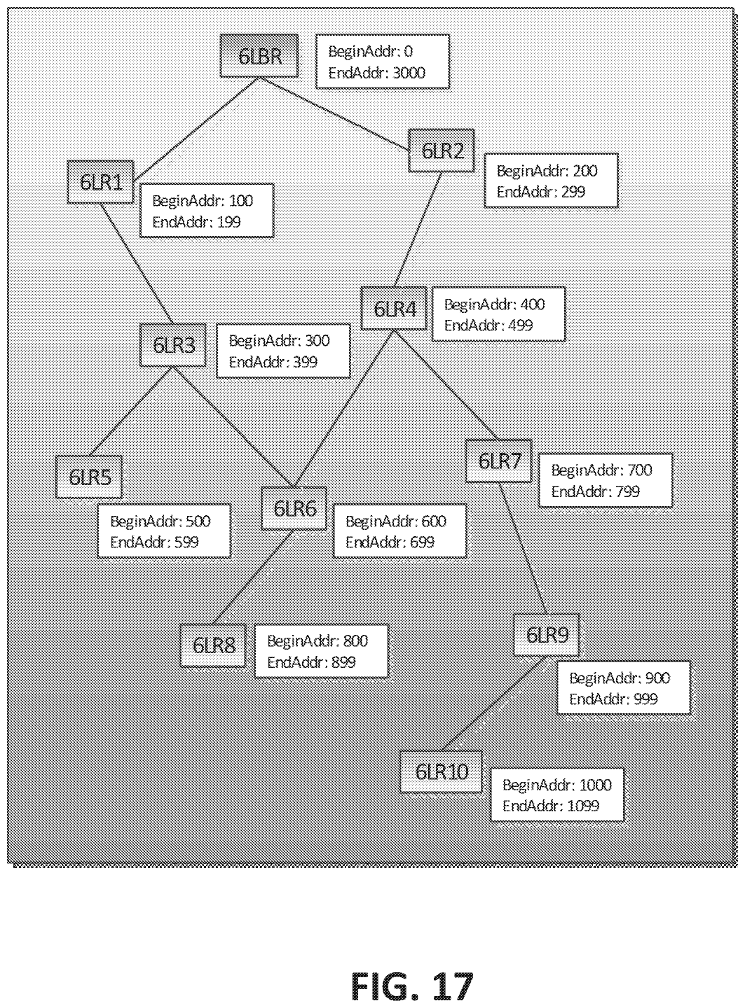

The processor 32 may access information from, and store data in, any type of suitable memory, such as the non-removable memory 44 and/or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer. The processor 32 may be configured to control lighting patterns, images, or colors on the display or indicators 42 to reflect the status of communications and to provide a graphical user interface, such as the GUI illustrated in FIG. 17 and described in the application.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the node 30. It will be appreciated that the node 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include various sensors such as an accelerometer, biometrics (e.g., fingerprint) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The node 30 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The node 30 may connect to other components, modules, or systems of such apparatuses or devices via one or more interconnect interfaces, such as an interconnect interface that may comprise one of the peripherals 52.

FIG. 6D is a block diagram of an exemplary computing system 90 which may also be used to implement one or more nodes of a network, such as the routers described in FIGS. 7-15, which may operate as an M2M server, gateway, device, or other node in an M2M network such as that illustrated in FIGS. 6A and 6B. Computing system 90 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 90 to do work, such as, for example, performing the operations illustrated and described in FIGS. 7-15 and the accompanying description. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86. For example, the display 86 may be used to display the graphical user interface illustrated in FIG. 17 and described above.

Further, computing system 90 may contain communication circuitry, such as for example a network adaptor 97, that may be used to connect computing system 90 to an external communications network, such as network 12 of FIG. 6A and FIG. 6B, to enable the computing system 90 to communicate with other nodes of the network. The communication circuitry, alone or in combination with the CPU 91, may be used to perform the steps described herein (e.g., FIGS. 7-15) and in the claims.

### Address Space Allocation to 6LRs

In an aspect of the application, routers within the 6LoWPAN network perform router discovery to find neighbor routers and also the 6LBR. Once the 6LBR is found, 6LRs can then send another RS message with two new parameters to be allocated an address space for assignment to 6LNs during address registration. The two new parameters are an Address Allocation (AA) request flag (AA_flag) and the optional Address Space Option (ASO) in which the router asks the 6LBR to reserve the indicated space. The AA_flag indicates to the 6LBR that the 6LR has the capabilities outlined in this disclosure and can serve as a registrar router to assign IP addresses to requesting 6LNs. The ASO option can be included to suggest to the 6LBR what address range the 6LR would like to be allocated. The 6LBR returns an RA message that contains the granted address space in an ASO and an optional Registration Token Option (RTO). The ASO returned to the 6LR could be the same as the requested ASO in the RS or it can be a new range that the 6LBR assigns to the 6LR. The RTO option is included so that the 6LR may be able to use the RTO in order to verify authorization of a 6LN performing the request. The RTO may be a random value or cryptographically generated based on a successful authentication process that was carried out in order to verify the node's credentials. Both the ASO and RTO options are configured by a network administrator during the setup of the network. Each 6LR will have its own ASO and RTO options to carry out the procedures outlined in this disclosure. When the 6LNs are deployed, they could be provisioned with the appropriate RTO or provided by other means to be granted authorization for address assignment. By providing the allocation, the 6LBR indicates to the 6LR that the address space is only assigned to the 6LR and any addresses within this space could be provisioned to 6LNs without the need to perform DAD.

FIG. 7 illustrates an embodiment where the 6LBR disseminates address spaces to 6LRs. The steps are denoted by Roman numerals, e.g., 1, 2, 3 etc. In Step 1a, the 6LR1 sends a RS message with AA_flag and a suggested ASO range it wants 6LBR to allocate it. In Step 1b, the 6LBR returns a RA message with an ASO option that may be the same range as the one provided in the RS or it could be a range that is different. In addition, 6LBR provides an RTO option for 6LR1's use. In Step 1c, the 6LR saves the ASO and RTO options as internal parameters it uses for assigning addresses. Then in Step 2a, the 6LR2 sends a RS message but with only the AA_flag. In Step 2b, the 6LBR sends a RA message with the ASO and RTO options. Since 6LR2 did not suggest an ASO, 6LBR assigns a range to 6LR2. In Step 2c, the same operations as step 1e are performed except by 6LR2. Subsequently in Steps 3a-3c, the procedures outlined in Steps 1a-1e are performed for 6LR3.

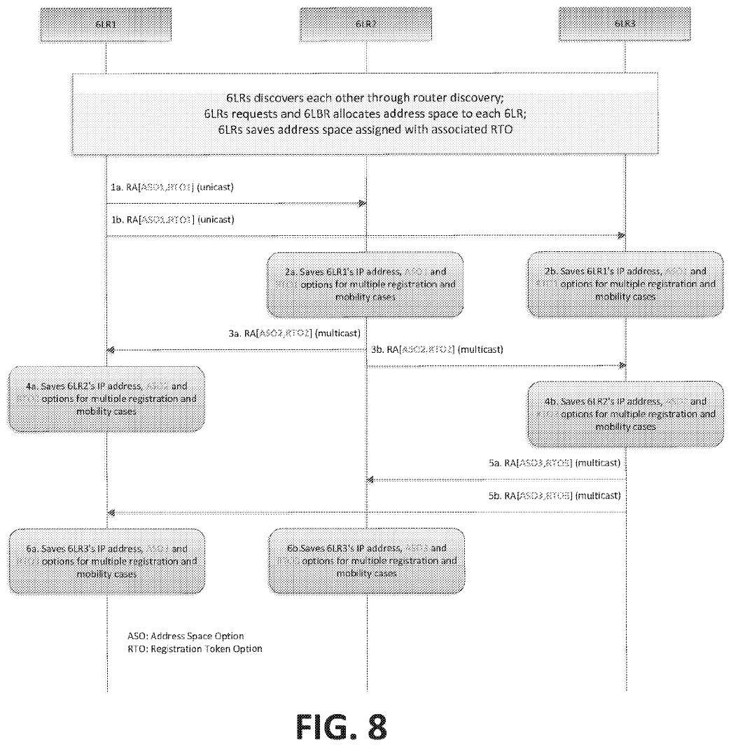

According to another embodiment, after the 6LRs have been allocated with address spaces by the 6LBR, each 6LR can communicate its address allocation to neighbor routers. This is done by including ASO and associated RTO options within a RA message as illustrated in FIG. 8. As part of the advertisements, the receiving 6LR will save the neighbor 6LR's IP address and the ASO and RTO options provided in the RA message. These advertisements will be used for multiple registrations and mobility cases described herein and are only sent after changes to each router's ASO values or upon discovery of new neighbor routers. The RA messages can be unicasted or multicasted to neighbor routers.

As shown in FIG. 8, each of the steps is denoted by Roman numeral. In Step 1a, the 6LR1 unicasts an RA message to 6LR2 with ASO1 and RTO1 options allocated to it by the 6LBR. In Step 1b, the 6LR1 unicasts an RA message to 6LR3 with ASO1 and RTO1 options allocated to it by the 6LBR. Then in Step 2A, the 6LR2 saves 6LR1's ASO1, RTO1, and an IP address in its internal data structure for neighbor routers. In Step 2b, the 6LR3 saves 6LR1's ASO1, RTO1, and an IP address in its internal data structure for neighbor routers. Subsequently in Steps 3a-3b, the 6LR2 multicasts RA with its allocated ASO2, RTO2 options to 6LR1 and 6LR3. Thereafter in Steps 4a-4b, the 6LR1 and 6LR3 save 6LR2's ASO2, RTO2, and an IP address in its internal data structure for neighbor routers. Further in Steps 5 and 6, the 6LR3 repeats Steps 3 and 4 with its ASO3 and RTO3 options to update 6LR1 and 6LR2's internal data structure for neighbor routers.

In another embodiment, a new data structure within the 6LRs is maintained in which the address space allocation is saved. When other 6LRs communicate their allocations, it is also saved into this data structure as well as the other 6LR's IP address. This allows the 6LR to quickly contact the neighbor 6LR to support multiple registration and mobility cases. Table 2 below includes an example address allocation data structure of all neighbor 6LRs maintained at 6LR1. Table 2 will be used during address registration, multiple registrations, and mobility cases as described further in this application. The RTO option is the one assigned to the neighbor 6LR and will be used by the local 6LR as an authorization check before contacting the remote 6LR in multiple registration and mobility cases. The link-local address is used to contact the neighbor router for multiple registration or mobility cases described later in the document. The address used here could be a link-layered address as well or some other address that the local 6LR can use to reach the neighbor 6LR.

TABLE 2

| | |
|---|---|
| IP Address | |
| Space | Link-Local |

| Router | Begin | End | RTO | Address |
|---|---|---|---|---|
| 6LR2 | 2000 | 2999 | RTO2 | FE80::200 |
| 6LR3 | 3000 | 3999 | RTO3 | FE80::300 |

In addition to the data structure that is maintained by the 6LR in Table 2, two other new parameters are kept to aid in assigning addresses. The first parameter ‘nextAddress’ holds the value of the next available address for assignment and the second parameter ‘totalAddress’ holds the total number of addresses left to be assigned. When an address registration is made from a 6LN, the 6LR assigns the 6LN the address in ‘nextAddress’ and increments its value for the next registration request. In addition, ‘totalAddress’ is decremented by one to show the total number of addresses remaining for assignment. For de-registration and address expiration cases, the ‘totalAddress’ is incremented by one as the allocated address is now free to be assigned. For the maintenance of the ‘nextAddress’ parameter, one approach is for the 6LR to continue assigning addresses until the end of its range. Once the end address is reached, the 6LR can parse its sorted NCE table to determine the next available address. The 6LR performs this until ‘totalAddress’ reaches zero, at which point the 6LR can request a new address space from the 6LBR.

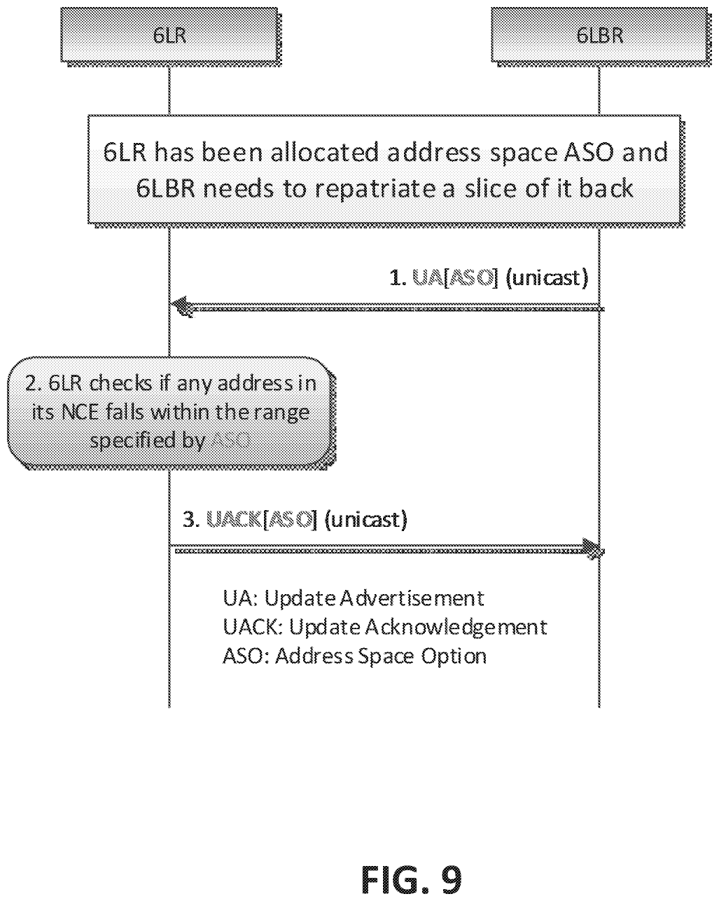

According to yet another embodiment, there may be times when the 6LBR may need to repatriate a slice of an address space that had previously been allocated to a 6LR. To accomplish this, the 6LBR performs the following steps each denoted by a Roman numeral in FIG. 9. In Step 1, 6LBR sends an Update Advertisement (UA) message with the ASO option, which contains a slice of previously allocated address space to 6LR. Then in Step 2, 6LR checks if there are any addresses in its NCE tables that falls within the range specified by ASO. If no address is found, the 6LR updates its internal parameters to reflect the new range. If an address is found, the 6LR may reduce the slice so no address is found in its NCE tables and return those addresses to 6LBR. Otherwise, it can generate an error to indicate it can't repatriate addresses. In Step 3, the 6LR sends a UACK message with an appropriate status code and the ASO option only if the addresses can be repatriate. If no addresses can be repatriated, the UACK message will not contain the ASO option.

Similarly, there may be times when 6LR may need to request an additional address space after it has assigned all addresses allocated to it. 6LR will perform the steps as outlined in FIG. 7 to obtain a new set of addresses.

### Streamlined ND Address Registration Without DAD

In another aspect of the application, once the 6LBR have disseminated the address allocations to the 6LRs, 6LNs can then perform address registration with its default router. There are two ways the 6LN address registration can occur. One way is by using a Request Address flag (AR_flag) in the RS message. Another way is by using the AR_flag in an NS message. FIG. 10 illustrates the 6LN using the RS message to request an address in (A) and using an NS message in (B).

The steps of FIG. 10 for using RS/RA messages for address registration are denoted by Roman numerals. Initially in Step 1, 6LN multicasts a RS message with the AR_flag set and the ARO option (this is the same option defined for NS message used in current ND address registration). In Step 2, 6LR assigns an address to 6LN using the Address Allocation (AAO) option. Then in Step 3, multiple 6LRs may receive the request from step 1 and return an RA message with the ARO and AAO options. The neighbor 6LRs unicast the RA message to 6LN. In Step 4, 6LN selects which of the 6LRs it wants to register to and returns a RACK message with both ARO and AAO options. Further in Step 5, the 6LR that receives the RACK message will use information in the ARO and AAO options to register the 6LN by adding to its NCE tables. For 6LRs that did not receive a RACK message, the internal parameters ‘totalAddress’ and ‘nextAddress’ return to their previous values.

According to another embodiment, the steps for using NS/NA messages for address registration are shown in FIG. 10. The steps are denoted as Roman numerals. In Steps 1-2, the 6LN performs router discovery as in current ND and selects a router to register to. In Step 3, the 6LN sends a NS message with the AR_flag set and the existing ARO option. In Step 4, the 6LR assigns the next available address ‘nextAddress’ to 6LN and registers [ARO,AAO] to its NCE. Subsequently in Step 5, the 6LR returns an NA message with [ARO,AAO] option to indicate the registration is complete.

The AAO provides the assigned address to 6LN. The AR_flag signals to the 6LR that the 6LN is requesting an address assignment. The flag can be included in the RS message to perform both router discovery and address registration procedures at the same time. Alternatively, it can be included in the NS message during current address registration procedure. When the 6LR receives either a RS or NS with the AR_flag, it obtains the next available address from ‘nextAddress’ and includes it in the Address Allocation Option (AAO) in the response, whether it is an RA or an NA message. At the same time, it adds the address registration information to its NCE table as is currently performed.

In the event the AR_flag is added to the RS message, the 6LN must return a Router Acknowledgment (RACK) message to the 6LR that it wants to register with. Notice that the RS message was multicast to all the neighbor routers and there may be multiple responses received by the 6LN. After deciding which 6LR it wants to register with, the 6LN sends a unicast RACK message with the ARO and AAO options. Upon receiving the RACK, the 6LR registers the information to its NCE table. For 6LRs that do not receive a RACK, no NCE entry is added and both nextAddress and totalAddress parameters revert to the previous values.

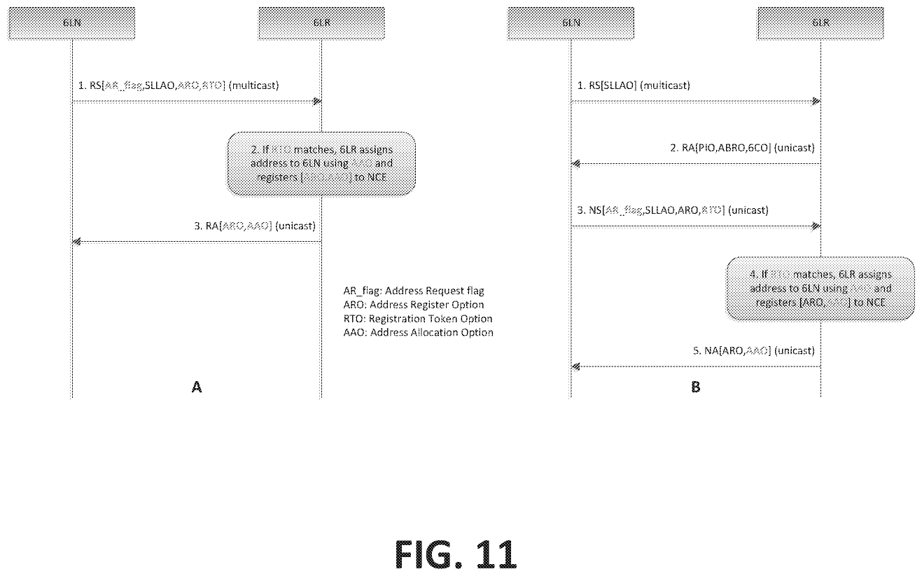

FIG. 11 shows the same scenarios as FIG. 10 with the inclusion of a Registration Token option (RTO) in the address registration request. Its inclusion removes the requirement that the 6LN return a RACK message since the presence of RTO will only generate one RA response. Each 6LR is configured with a unique RTO and only the 6LR who has a matching RTO will return an RA message. Further, the RTO is used as an authorization mechanism and may trigger an authentication procedure for the 6LR to verify the credentials of the 6LN.

In another embodiment, the call flows in FIG. 11 are each denoted by a Roman numeral. In Step 1, the 6LN multicasts a RS message with the AR_flag set, the ARO option, and the RTO. Then In Step 2, the 6LR checks the provided RTO against its own RTO; if the RTOs match, 6LR assigns an address to 6LN using the Address Allocation (AAO) option and registers [ARO,AAO] to its NCE table. If RTOs do not match, 6LR discards message and generate error response that is included in RA. In Step 3, the 6LR sends an RA with ARO and AAO options to complete the registration procedure with appropriate response code.

In another embodiment, with respect to FIG. 11, a process is described including Steps 1 and 2 defined by a 6LN performing router discovery as in current ND and selecting a router to register to. In Step 3, the 6LN sends an NS message with the AR_flag set, the existing ARO option, and the RTO. In Step 4, the 6LR checks the provided RTO against its own RTO. If the RTOs match, 6LR assigns an address to 6LN using the Address Allocation (AAO) option and registers [ARO,AAO] to its NCE table. If RTOs do not match, 6LR discards message and generate error response that is included in NA. Further, in Step 5, the 6LR returns a NA message with [ARO,AAO] option to complete the registration procedure with appropriate response code.

### Support for Address Registrations to Multiple Routers

According to another aspect of the application, support for address registrations to multiple routers is described. When a 6LN registers to a registrar router, it can indicate that it would like to extend the registration to nearby routers by including a Multiple Registration (MR_flag) flag in a NS message. Extending the registration means that the 6LN wants to register the same address to multiple nearby routers.

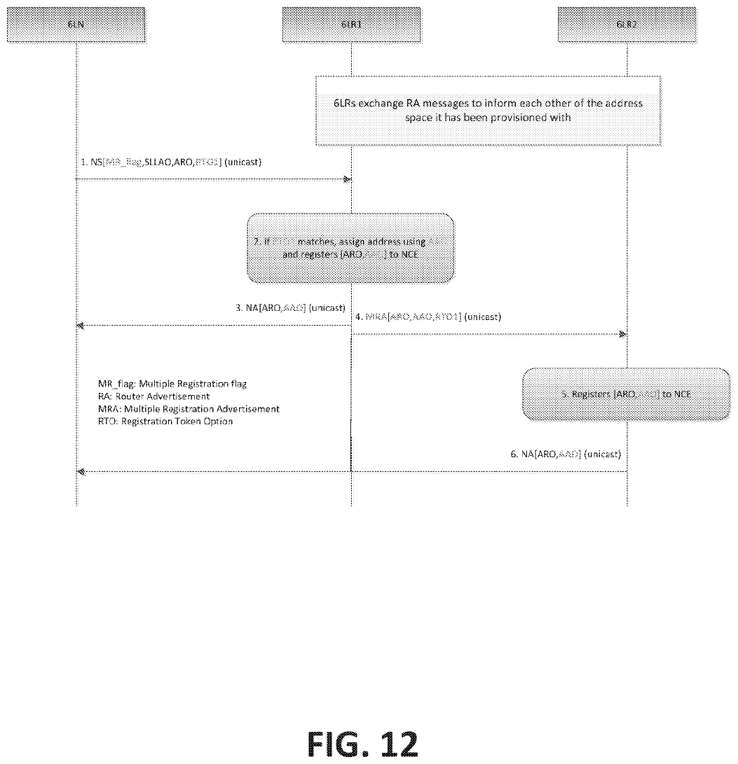

FIG. 12 illustrates the call flow registration to multiple routers. A 6LN includes a MR_flag within a NS message and the RTO option. 6LR1 is the registrar router and receives the multiple registration requests. It performs the appropriate internal checks to see if the provided RTO matches its own. If there is a match, 6LR1 assigns an address to 6LN from the nextAddress parameter and registers the information into its own NCE. Then it returns an NA message with the ARO and AAO options to complete the registration.

Since the MR_flag was set in the original request, 6LR1 also sends a Multiple Registration Advertisement (MRA) to 6LR2 with both the ARO and AAO options it provided to 6LN. Note that by using the same ARO and AAO options, the 6LR1 is registering 6LN with the same address to the neighbor 6LRs. 6LR1 looks up its data structure shown in Table 2 to find all neighbor routers. It then sends the MRA to the routers. 6LR2 receives MRA and registers 6LN's ARO and AAO to its own NCE. It then sends a NA with both ARO and AAO back to 6LN to indicate the address registration was successful. The 6LN notes the source IP address of the NA message to realize the registration was performed on a neighbor router rather than the default router.

The steps of FIG. 12 are described below and denoted by Roman numerals. In Step 1, 6LN unicasts a NS message with the MR_flag set and with the SLLAO, ARO, and RTO1 options. In Step 2, 6LR1 checks the provided RTO1 against its own RTO1. If the RTOs match, 6LR1 assigns an address to 6LN using the Address Allocation (AAO) option and registers [ARO,AAO] to its NCE table. 6LR1 becomes the home registrar router for 6LN since it provides the address from its allocated space. If RTOs do not match, 6LR1 discards message and generate error response that is included in NA According to Step 3, 6LR1 returns an NA with ARO and AAO options to complete the registration procedure with the appropriate response code. Then in Step 4, 6LR1 sends an MRA with the ARO, AAO, and RTO1 options to extend the registration to neighbor routers. In Step 5, 6LR2 checks the RTO1 against the ones in its data structure as shown in Table 2 and verifies if they match. If there is a match, 6LR2 registers 6LN's [ARO,AAO] to its NCE tables. The information from the registration could be provided to routing protocols to aid in routing messages to 6LN. If there is no match, 6LR2 discards the request. Lastly in Step 6, if step 5 is successful, 6LR2 sends an NA with [ARO,AAO] to 6LN. 6LN determines which 6LRs it is registered to by looking at the source IP address provided in the NA message. Since 6LR1 is the home registrar router for 6LN, it must synchronize registrations among the neighbor routers. The synchronization involves two parts: registration lifetime and de-registration. The registration lifetime is synchronized with MRA messages. For de-registration, 6LR1 must notify neighbor routers of the fact so all 6LN's registration is removed. In the case 6LN de-registers to a 6LR that is not the home registrar router, that 6LR must notify the home registrar router (using information from Table 2) so it can notify all neighbor routers to de-register 6LN.

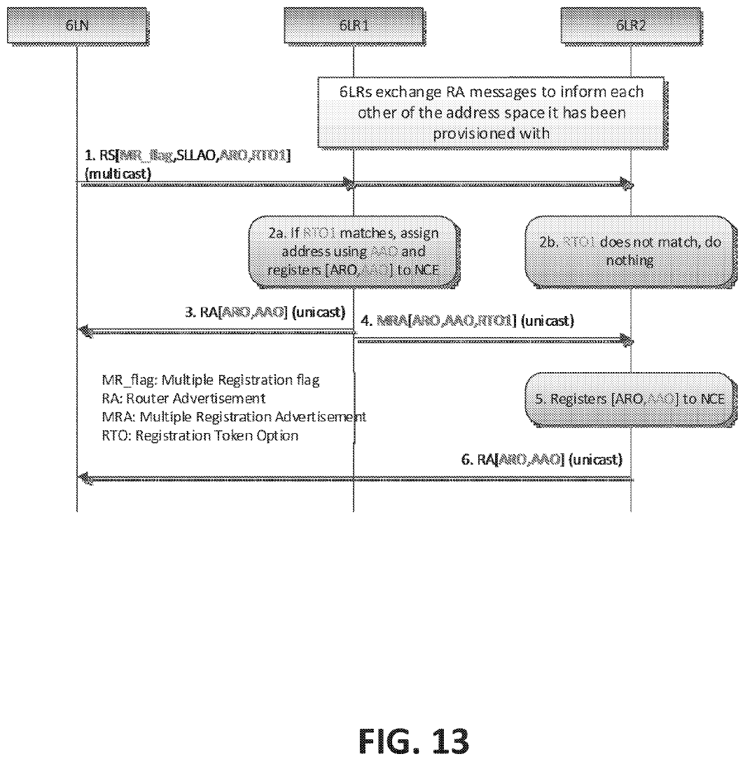

Similarly, multiple registrations may be triggered using RS messages. In another embodiment, FIG. 13 illustrates the incorporation of the MR_flag within the RS message. Since the RS is multicast to all nearby routers, each 6LR will make a determination whether the provided RTO matches its own. In this case, 6LR1 has a matching RTO and processes the request as previously described. 6LR2 does not have a matching RTO and hence, it does nothing. 6LR1 returns an RA with ARO and AAO options to complete 6LN's registration with itself. It then sends an MRA message with the same ARO and AAO options to 6LR2. 6LR2 registers the options to its NCE and returns an RA message to 6LN. The 6LN determines which 6LRs it is registered to by looking at the source IP address provided in the NA message.

The steps of FIG. 13 are denoted by Roman numerals. In Step 1, 6LN multicasts a RS message with the MR_flag set and with the SLLAO, ARO, and RTO1 options. Next, in Step 2a, 6LR1 checks the provided RTO1 against its own RTOI. If the RTOs match, 6LR1 assigns an address to 6LN using the Address Allocation (AAO) option and registers [ARO,AAO] to its NCE table. 6LR1 becomes the home registrar router for 6LN since it provides the address from its allocated space. In Step 2b, 6LR2 checks the provided RTO1 against its own RTO2. The RTOs do not match and 6LR2 discards the request and does nothing. Then in Step 3, 6LR1 returns an RA with ARO and AAO options to complete the registration procedure with the appropriate response code. In Step 4, 6LR1 sends an MRA with the ARO, AAO, and RTO1 options to extend the registration to neighbor routers. Next in Step 5, 6LR2 checks the RTO1 against the ones in its data structure as shown in Table 2 and verifies if they match. If there is a match, 6LR2 registers 6LN's [ARO,AAO] to its NCE tables. The information from the registration could be provided to routing protocols to aid in routing messages to 6LN. If there is no match, 6LR2 discards the request. Further in Step 6, if step 5 is successful, 6LR2 sends an RA with [ARO,AAO] to 6LN. 6LN determines which 6LRs it is registered to by looking at the source IP address provided in the RA message. In an exemplary embodiment, 6LR1 must maintain synchronization among neighbor routers of 6LN's registrations.

### Support for Multiple Address Registrations to Different Routers

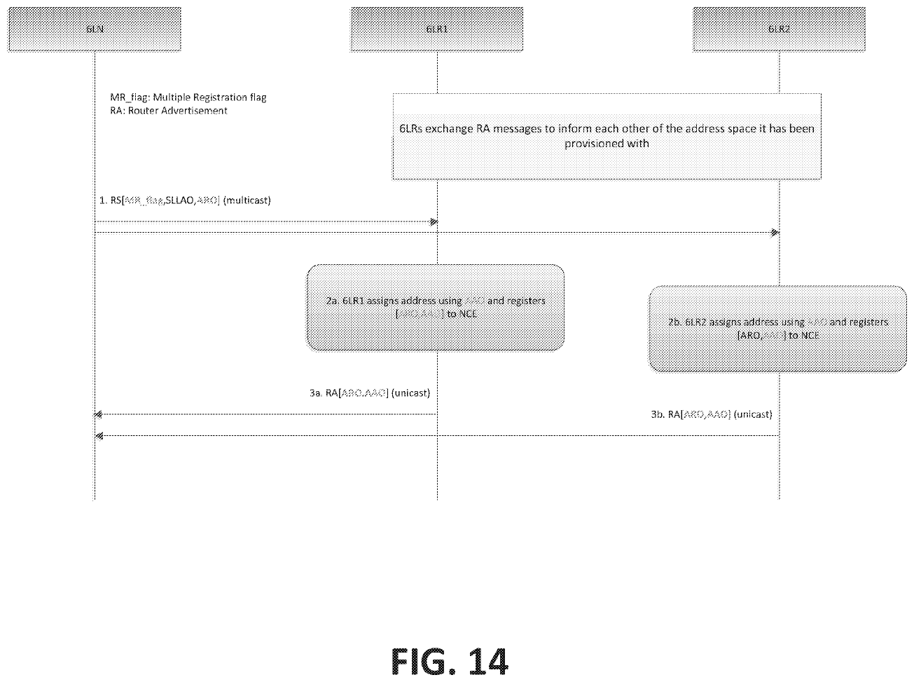

According to even another aspect of the application, a 6LN may want to obtain multiple addresses from different routers for load balance purposes. The streamlined ND address registration procedure described earlier in this application may be extended to support multiple registrations to different 6LRs when the RTO option is not used. FIG. 14 illustrates the call flow for this case. Each of the steps is denoted by a Roman numeral. In particular, 6LN sends an RS message with the MR_flag to all nearby routers on the link. 6LR1 and 6LR2 receives the RS message and each performs its internal processing to assign an address to 6LN. Each 6LR registers 6LN to its NCE tables and provides an RA with ARO and AAO options. The AAO option is different between the two RA messages—each one represents the address assigned to 6LN from the respective 6LRs. Note that either the AR_flag or MR_flag could be use in this case to trigger multiple registrations. If AR_flag was used, then 6LN should send a RACK message to each LR to accept the address assignment.

According to Step 1of FIG. 14, the 6LN multicasts a RS message with the MR_flag set and with the SLLAO and ARO options. In Step 2a, the 6LR1 assigns an address within its allocated space to 6LN using the Address Allocation (AAO) option and registers [ARO,AAO] to its NCE table. In Step 2b, the 6LR2 assigns an address within its allocated space (which will be different from the address assigned by 6LR1) to 6LN using the Address Allocation (AAO) option and registers [ARO,AAO] to its NCE table. In Step 3a, the 6LR1 returns a RA with ARO and AAO options to complete the registration procedure with the appropriate response code. In Step 3b, 6LR2 returns an RA with ARO and AAO options to complete the registration procedure with the appropriate response code.

Support for 6LN Mobility within the Local Link

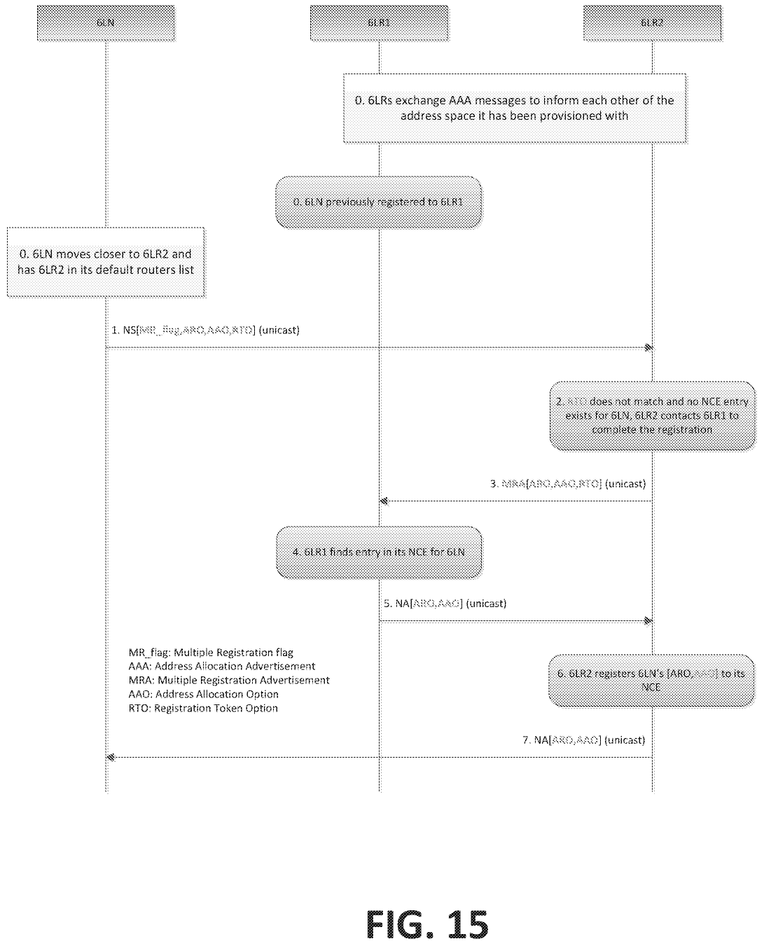

According to even a further embodiment in 6LoWPAN, 6LN mobility can be an issue as the node moves about within the local link or links are dropped due to its lossy nature. The procedure illustrated in FIG. 15 helps support mobility within the local link. The steps of FIG. 15 are denoted by Roman numeral. As pre-requisites for this call flow and indicated by multiple step 0's, the 6LRs have discovered each other and have knowledge of each other's address allocation, 6LN previously is registered to 6LR1, and 6LR2 is in 6LN's default router list. Prior to the start of the call flow, 6LN moves closer to 6LR2 and would like to register to it. Here, the 6LN determines that it has moved since it detects through existing Neighbor Unreachability Detection (NUD) that it has lost connectivity to 6LR1. 6LN uses a NS message with the MR_flag to register to 6LR2, which is found in the list of default routers determined during router discovery.

The mobility support procedure is as follows in reference to FIG. 15 and the steps are denoted by Roman numerals. In Step 1, the 6LN unicasts a NS message with the MR_flag as well as the other options shown in the diagram. In this case, an RTO option is included. In Step 2, the 6LR2 receives the message and determines that RTO does not match its own RTO and also there are no NCE entries for 6LN. In Step 3, the 6LR2 checks its neighbor routers list and determines RTO matches that of 6LR1. It then sends an MRA message with the ARO, AAO, and RTO options to 6LR1. In Step 4, the 6LR1 finds an entry in its NCE table for 6LN. At this point, 6LR1 may provide information to the routing protocol to forward messages targeting 6LN to 6LR2. In addition, 6LR1 synchronizes its registration lifetime with the updated one from 6LR2 so it does not expire before the registration on 6LR2 expires. As a result, the assigned address for 6LN does not get re-assigned to another 6LN within 6LR1. In Step 5, the 6LR1 returns an NA message with the ARO and AAO options to indicate to 6LR2 that 6LN's registration is valid.

Further in Step 6, the 6LR2 adds an entry to its NCE table to register 6LN. 6LR2 now becomes the current registrar router that maintains the registration information for 6LN. If 6LN de-registers before its registration expires, 6LR2 must notify 6LR1 of the fact so the address can be freed up within 6LR1 for assignment to other 6LNs. 6LR1, being the home registrar router because it assigned 6LN an address from its address space, must notify all neighbor routers to de-register 6LN. Subsequently in Step 7, the 6LR2 returns an NA message with ARO and AAO options to complete the registration of 6LN.

Additions to Address Registration Procedure within 6LR

According to even a further aspect of the application, the address registration procedure could be performed with either RS or NS message. In this embodiment, new state diagram transitions for each procedure are described. The 6LR will implement these state transitions to support the proposed concepts in this application.

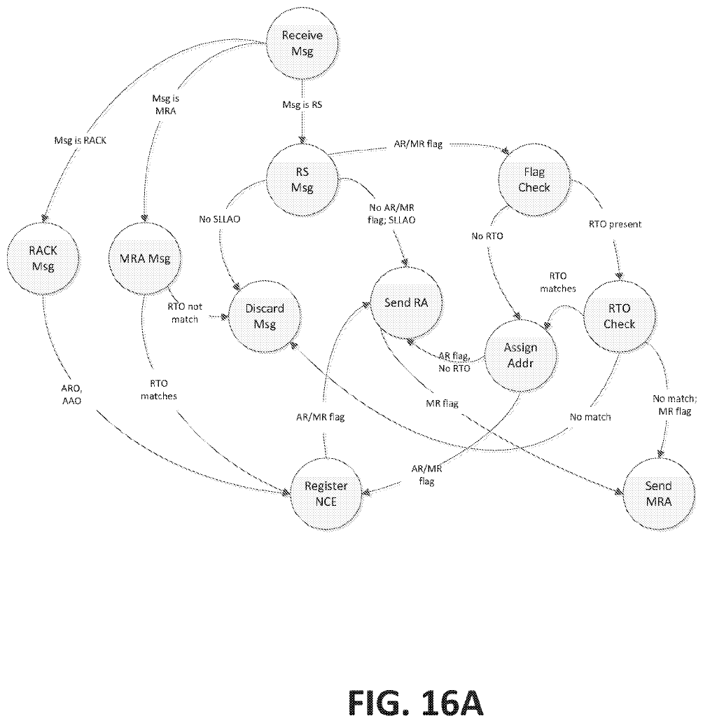

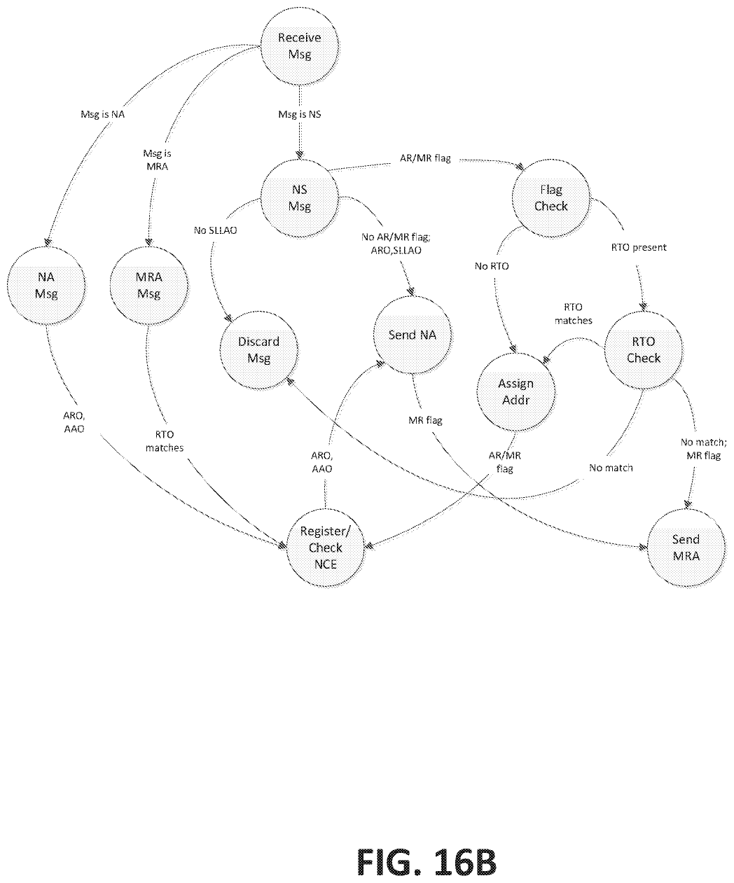

In an exemplary embodiment, FIG. 16A illustrates a state diagram for address registration using RS messages. Three types of messages can be received: (1) an RS message in which the request is made, (2) a RACK message in which a 6LN acknowledges the selection of 6LR as registrar router, and (3) an MRA message use for registrations to multiple routers. Descriptions of the state diagram includes the following:

(1) If message is RACK, 6LR will register the [ARO,AAO] options to its NCE and send a corresponding RA message with those options to 6LN;

(2) If message is MRA, 6LR will register the [ARO,AAO] options to its NCE (if the provided RTO matches one within 6LR) and send a corresponding RA message with those options to 6LN. If RTO does not match, 6LR discards message;

(3) If message is RS and no AR/MR_flags are included, then operation defaults to existing ND states: (a) If SLLAO is provided, 6LR sends RA message; and (b) If no SLLAO is provided, 6LR discard message; or

(4) If message is RS and either AR or MR_flag is included, 6LR checks whether RTO is included: (a) If no RTO is included, 6LR assigns an address to 6LN and sends RA message; and (b) If RTO is included, 6LR moves to Check RTO state; (i) If provided RTO matches 6LR's RTO, 6LR assigns address and registers [ARO,AAO] to its NCE, and an RA is returned to 6LN with [ARO,AAO], whereby if MR_flag is set, send MRA message; and (ii) If RTO does not match but MR_flag is set, send MRA message; and (iii) If RTO does not match, discard the message.

According to another embodiment as shown in FIG. 16B, the state diagram for address registration using NS message is described. Three types of messages can be received: 1) a NS message in which the request is made, 2) a NA message in which a 6LR acknowledges to another 6LR the registration of 6LN use during mobility cases, and 3) a MRA message use for registrations to multiple routers and mobility case.

Descriptions of the state diagram include the following:

(1) If message is NA, the 6LR will register the [ARO,AAO] options to its NCE and send a corresponding RA message with those options to 6LN;

(2) If message is MRA, the 6LR will check if the 6LN is already registered with itself; (a) If yes and provided RTO matches 6LR's, send NA with success registration status; (b) If no and provided RTO matches 6LR's, send NA with no registration status; (c) If no and provided RTO does not match 6LR's but matches a neighbor 6LR, register the [ARO,AAO] options to its NCE and send a corresponding RA message with those options to 6LN; and (d) otherwise send NA with appropriate error status;

(3) If message is NS and no AR/MR_flags are included, then operation defaults to existing ND states: (a) If ARO and SLLAO are provided, 6LR sends RA message; and (b) If no SLLAO is provided, 6LR discard message; or

(4) If message is NS and either AR or MR_flag is included, 6LR checks whether RTO is included: (a) If no RTO is included, 6LR assigns an address to 6LN, registers [ARO,AAO] to its NCE and sends NA message; (ii) If RTO is included, 6LR moves to Check RTO stat3: (i) if provided RTO matches 6LR's RTO, 6LR assigns an address to 6LN, registers [ARO,AAO] to its NCE and sends NA message, wherein if MR_flag is set, send MRA message; (ii) if RTO does not match but MR_flag is set, send MRA message; and (iii) If RTO does not match, discard the message.

### Graphical User Interface

In an exemplary embodiment of the application, a GUI may be created at the 6LBR to provide network administrators the ability to configure the address space of each 6LR. FIG. 17 illustrates how the above-mentioned concepts of this application can be displayed via a GUI. In the GUI, the address space for each 6LR is shown. A user can select a particular 6LR through a touchscreen interface and change the allocated space varying the ‘BeginAddr’ or ‘EndAddr’ fields.

In FIG. 17, the GUI interface can be used to display the changes of parameters/resources during the operation. In one embodiment, the GUI on a display may include returned results matching certain search parameters. The search parameters may be based upon resource type, resource creation time, resource size, etc. For instance, ‘k’ resources matching the filter criteria may be displayed on the GUI. In addition, the number of router hops is displayed. According to an exemplary embodiment, the GUI may be displayed as an “Automatic Meter Reader” application. The application may include a user-interface whereby users may enter information such as search parameters. By so doing, the GUI outputs a result indicating the number of available free addresses. Various applications of these networks may also include applications in industrial and office automation, connected homes, agriculture, and smart meters and may be viewed and operated by a user via the GUI.

The processor 32 may be configured to control lighting patterns, images, or colors on the display or indicators 42 in response to whether the learning management system in some of the examples described herein are successful or unsuccessful, e.g., service requests, context retrieval, or context notification, etc., or otherwise indicate a status of routers and associated components. The control lighting patterns, images, or colors on the display or indicators 42 may be reflective of the status of any of the method flows or components in the Tables or FIGs. illustrated or discussed herein, e.g., FIGS. 7-15. Disclosed herein are messages and procedures of routers. The messages and procedures can be extended to provide interface/API for users to request resource-related resources via an input source, e.g., speaker/microphone 38, keypad 40, or display/touchpad 42, and request, configure, or query node associated information, among other things that may be displayed on display 42.

Moreover, FIG. 17 illustrates an exemplary display, e.g., graphical user interface that may be generated based on the methods and systems discussed herein. The display interface, e.g., touch screen display, may provide text associated with node or router selection, such as the parameters of Table 2. In another example, progress of any of the steps discussed herein may be displayed. In addition, graphical output may be displayed on display interface.

### Embodiments

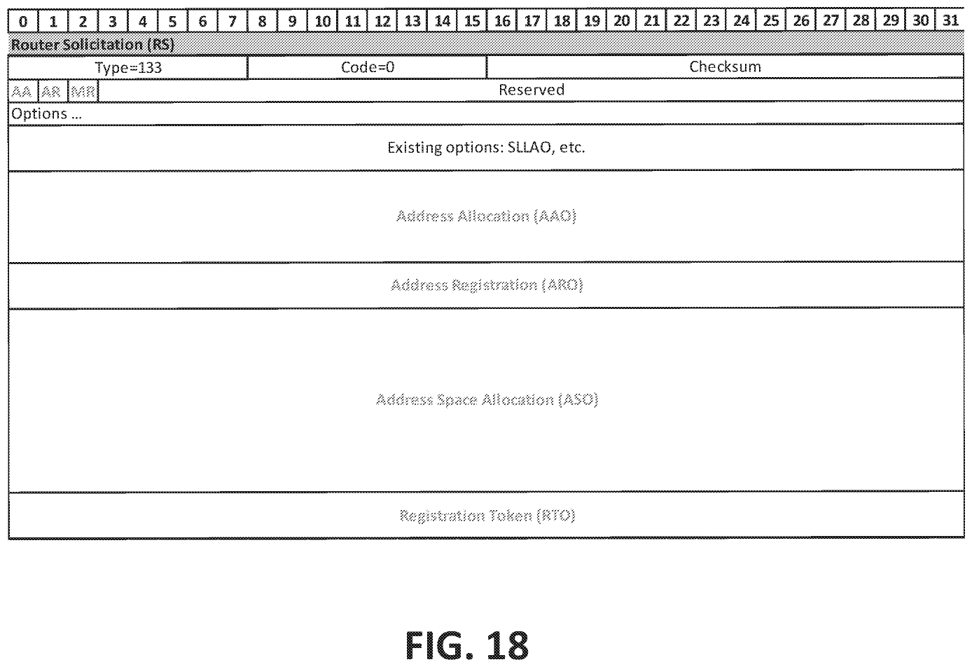

According to an exemplary embodiment, IPv6 ND messages are encoded as ICMPv6 messages. These messages may be add-ons to existing message types by way of introducing new flags or options. The RS message is used by nodes to obtain information provided by routers about the network. A node multicasts this message to all routers and will receive RA messages in return. FIG. 18 illustrates the proposed additions to this message to support the ideas presented in this application. The following terms describes each flag and option in FIG. 18.

AA_flag: This flag is sent by 6LRs to request a 6LBR for allocating address space that 6LR can use to assign addresses to requesting nodes.

AR_flag: This flag is included to indicate a node is requesting the assignment of an address from the 6LR.

MR_flag: This flag signifies that the requesting node would like to perform address registration with all routers that receive the multicast message if the conditions of the request are met. When use with the RTO option, the router whose RTO matches would then register the node to neighbor routers using MRA message.

Address Allocation (AAO): This option is used when an already registered node wants to register to a nearby router due to mobility of the node. It specifies the address that is assigned to the requesting node and registered to another 6LR that the node has lost contact with. The receiving 6LR should use this address to confirm with the router of the original registration before adding the registration to its NCE tables.

Address Registration (ARO): This is the ARO option found in existing NS message that is used for address registration. It includes a Unique Interface Identifier (UIID), a registration lifetime, TID, and bits used to identify the ID namespace used for the UIID. This option is required for allowing nodes to use RS message to request address registration.

Address Space Allocation (ASO): Within this option, a beginning and an end address value should be specified. The width will depend on the prefix assigned to this segment of the network. This option allows 6LRs to request a specific address space from the 6LBR.

Registration Token (RTO): When RS message is used to request address registration, RTO option can be included so that the 6LR is able to use the RTO in order to verify authorization of a 6LN performing the request. The RTO may be a random value or cryptographically generated based on a successful authentication process that was carried out in order to verify the end node's credentials

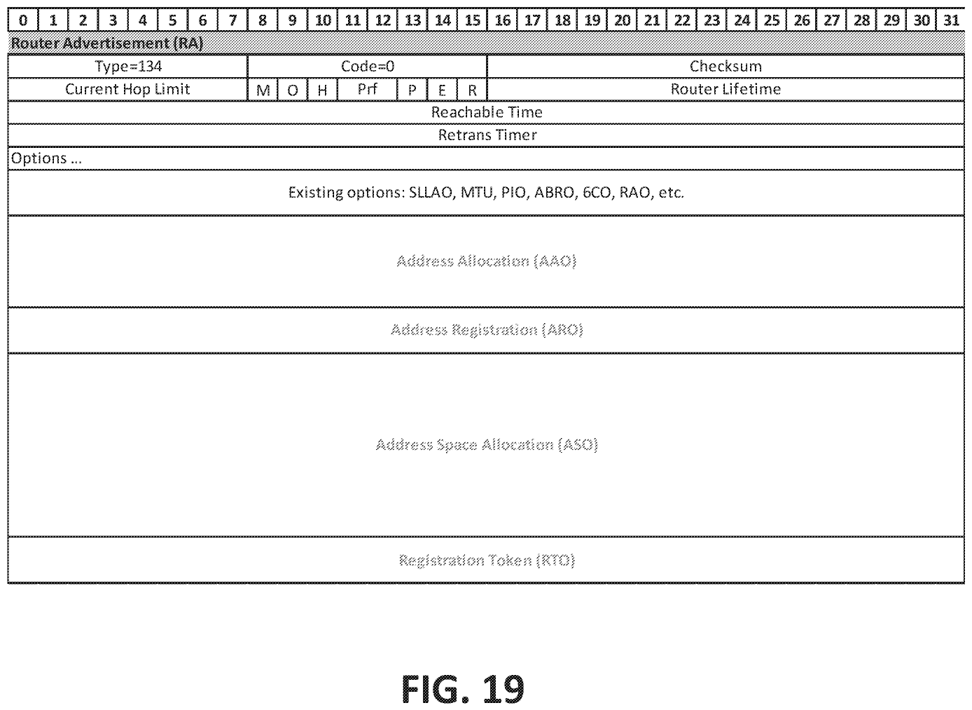

In another embodiment, the RA message is sent in response to an RS message. Occasionally, it may be sent unsolicited to quickly convey changes in network parameters. If the RS message was use for address registration, the status of the registration is provided in the ARO option that is returned. As seen in FIG. 19, there are many parameters associated with this message and the inclusion of certain parameters depends on what was requested in the RS message. The following information in FIG. 19 is described in more detail.

Address Allocation (AAO): By including the AAO option, the 6LR is confirming that the address provided is registered with the 6LR's NCE. The requesting node can then use this address to communicate with other nodes.

Address Registration (ARO): The 6LR returns the ARO option (along with the AAO) to complete the address registration procedure.

Address Space Allocation (ASO): The ASO included in an RA message signifies the address space a 6LBR has provisioned to the requesting 6LR. The 6LR can then assign addresses within this space during address registration procedure.

Registration Token (RTO): Similar to ASO, the RTO returned in an RA message indicates the token granted to the requesting 6LR. The 6LR uses this token to verify authorization of a 6LN performing an address registration.

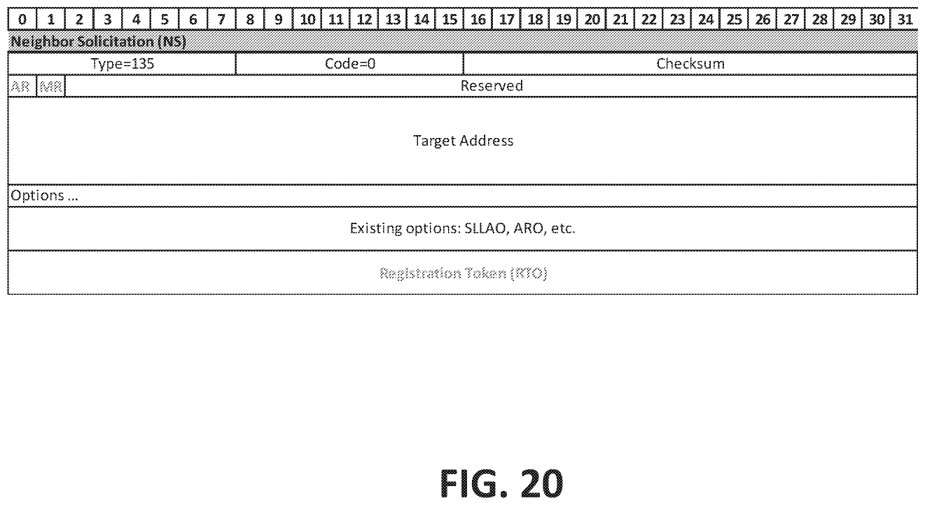

According to yet another exemplary embodiment, new flags and options are added to the message shown in FIG. 20. Typically, in ND, a NS message is unicast to a registrar router to trigger the address registration procedure. A NA message is returned by the router to complete the address registration. FIG. 20 shows the new flags and option added to this message. The new flags include:

AR_flag: This flag is included to indicate a node is requesting the assignment of an address from the 6LR.

MR_flag: This flag signifies that the requesting node would like to perform address registration with the targeted router if the conditions of the request are met. The targeted router would then register the node to neighbor routers using MRA message.

Registration Token (RTO): The RTO option is included to indicate to 6LRs that the node can be assigned an address. It serves as an authorization mechanism for a 6LN to perform address registration with the 6LR.

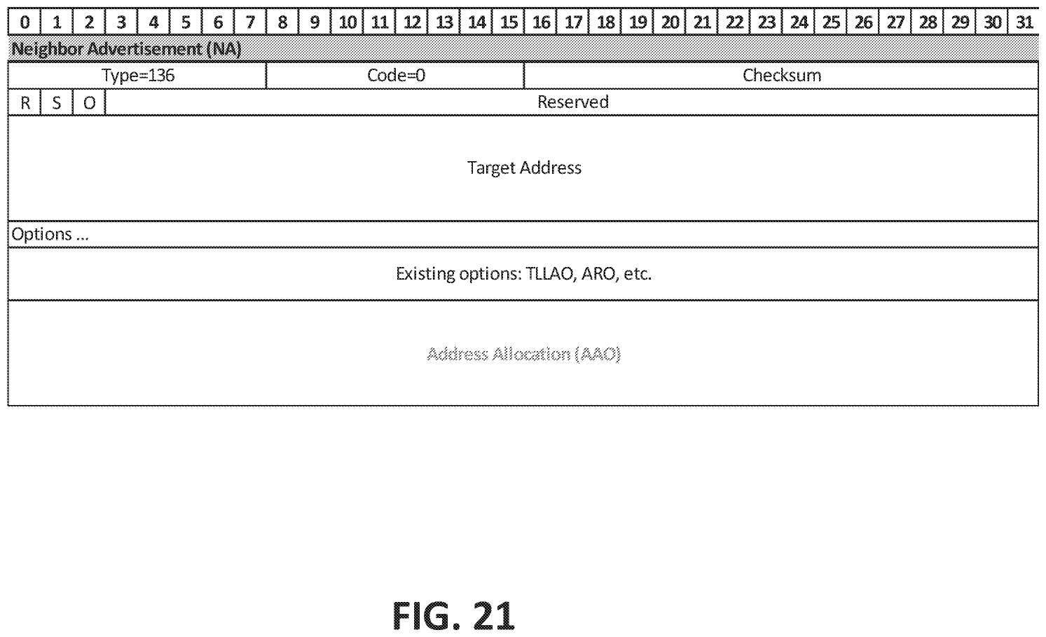

In yet a further exemplary embodiment, as shown in FIG. 21, the NA message is returned in response to a NS message. The status of the registration is provided in the returned ARO option. In addition, if an address was assigned during registration, it is included in the AAO option. The following describes what information each option should contain:

Address Allocation (AAO): By including the AAO option, the 6LR is confirming that the address provided is registered with the 6LR's NCE. The requesting node can then use this address to communicate with other nodes.

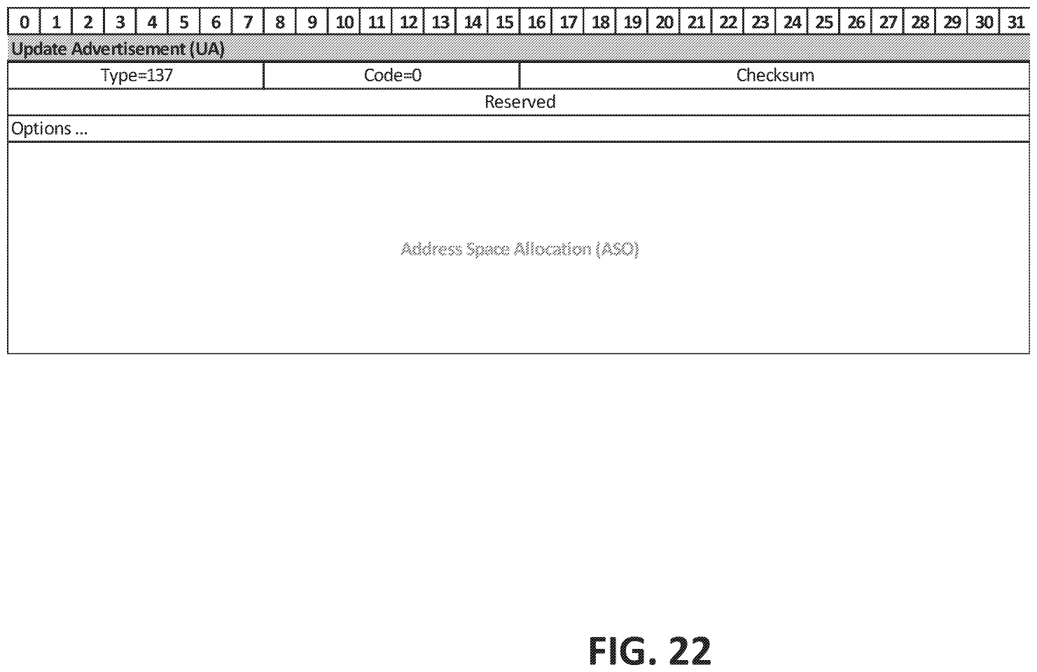

According to another exemplary embodiment, the update advertisement (UA) message is described. For example, as shown in FIG. 22, this new message supports 6LBR to repatriate a slice of an already allocated address space from 6LRs. The UA is sent by the 6LBR with the ASO option, which contains the requested slice that is to be repatriated. The following describes what information each option should contain:

Address Space Allocation (ASO): The ASO included in a UA message signifies the slice of an address space a 6LBR wants to repatriate from the 6LR.

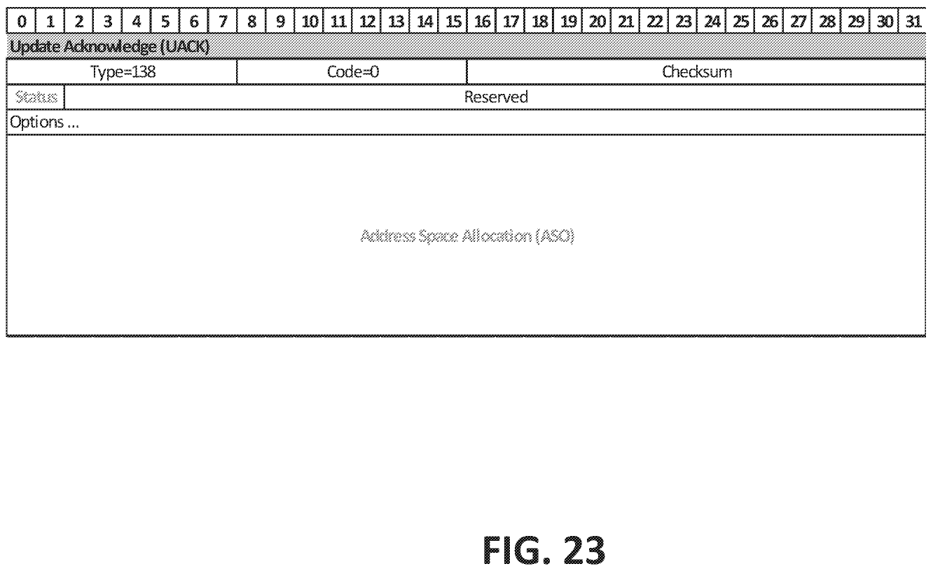

In yet another exemplary embodiment, the update acknowledgment message is described. As shown in FIG. 23, this new message supports repatriating a slice of an already allocated address space from 6LRs. The UACK is returned by the 6LR in response to a UA request from the 6LBR. It provides the status for the request and if addresses are repatriated, the slice of address that will be given back to 6LBR. The following describes what information each flag means and what each option should contain:

Status_flag: This flag provides the status of the UA request to repatriate a slice of address from 6LR. The decoded values are: 0=Cannot repatriate; 1=Repatriate the requested ASO slice; 2=Repatriate a smaller slice than the requested ASO slice; and 3=Repatriate a slice different than the requested ASO slice.

Address Space Allocation (ASO): The ASO included in a UACK message signifies the slice of an address space a 6LR can repatriate to 6LBR.

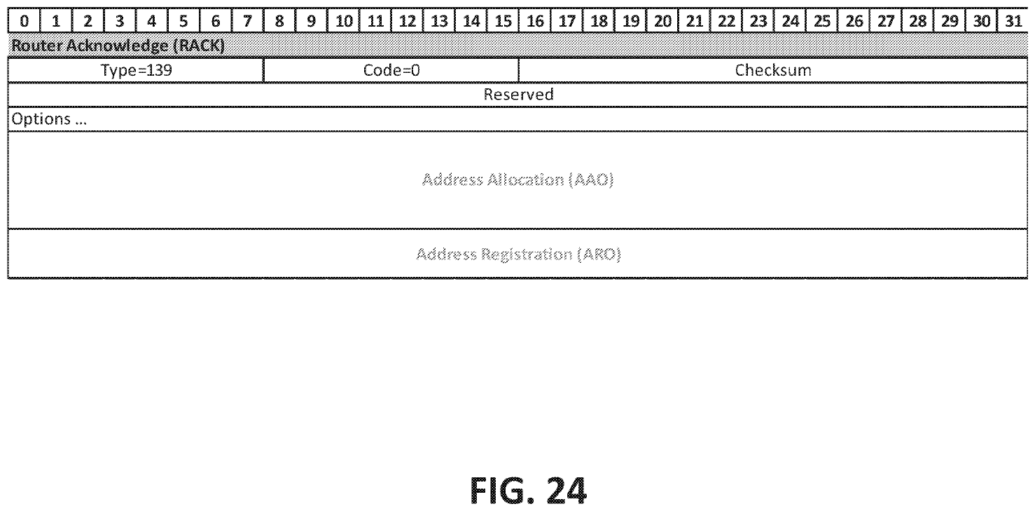

According to yet another embodiment, a router acknowledges message is described. As shown in FIG. 24, this is a new message to support address registration using an RS message. The RACK is returned by a node when address registration uses RS message without an RTO option. Since the RS is multicast to all routers, the node may receive multiple RA messages. It then selects the router it wants to register with and returns the RACK. The following describes what information each option should contain:

Address Allocation (AAO): By including the AAO option, the node confirms that it wants to be registered with the targeted router.

Address Registration (ARO): The node returns the ARO option (along with the AAO) to complete the address registration procedure.

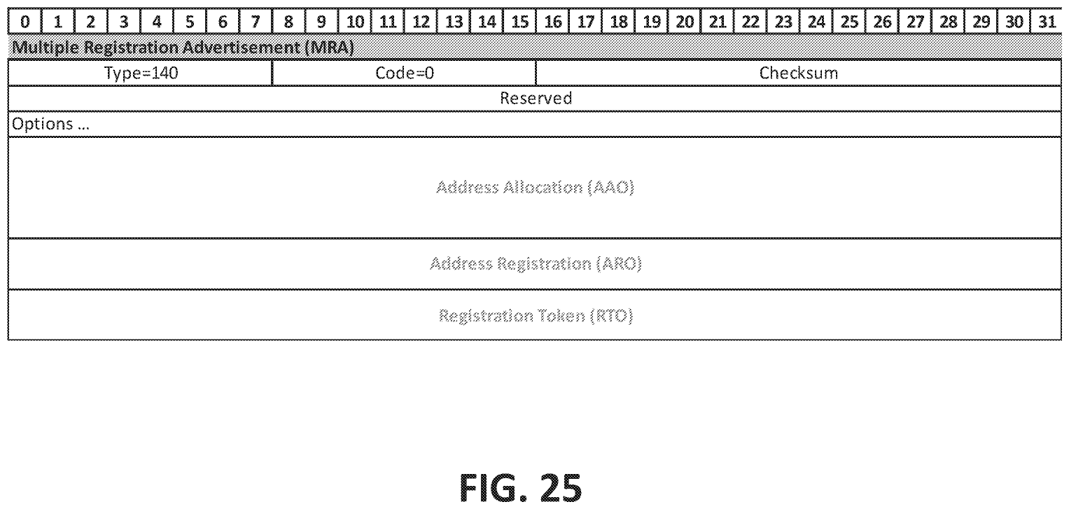

In yet even a further exemplary embodiment, the MRA message is sent by routers to other routers to register a 6LN to multiple routers. As shown in FIG. 25, in the original request, the 6LN sets the MR_flag to indicate it wants to register to multiple routers. The targeted router first registers the 6LN to itself and then sends MRA messages to neighbor routers so the 6LN can be registered to them as well. In addition to supporting multiple registrations, the MRA is also used in mobility cases in which a node has lost communication with the router it is registered to and would like to register to another router while preserving the original registration. The following describes what information each option should contain:

Address Allocation (AAO): The targeted 6LR includes the AAO option to register the address on neighbor routers.

Address Registration (ARO): The targeted 6LR provides the ARO option (along with the AAO) to register the requesting node on neighbor routers.

Registration Token (RTO): The targeted 6LR includes the RTO that is associated with the node's registration.

While the systems and methods have been described in terms of what are presently considered to be specific aspects, the application need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

What is claimed is:

1. An apparatus comprising:
a non-transitory memory having instructions stored thereon for allocating address space; and
a processor, operably coupled to the non-transitory memory, the processor configured to perform the steps of:
locating a router on a network;
sending a router solicitation message including an address allocation flag to the router to reserve the address space;
receiving a router advertisement message based upon the router solicitation message including an address space option; and
saving the address space option provided in the router advertisement.

2. The apparatus of claim 1, wherein the address space option recommends an allocatable address range.

3. The apparatus of claim 2, wherein the address space option in the received router advertisement is contingent upon the suggested address space option in the router solicitation message.

4. The apparatus of claim 1, wherein the received router advertisement message includes a registration token option for verifying authorization of a node.

5. The apparatus of claim 1, wherein the located router is a border router.

6. An apparatus comprising:
a non-transitory memory having instructions stored thereon for communicating address space between routers; and
a processor, operably coupled to the non-transitory memory, the processor configured to perform the steps of:
receiving a message including an address space option from a router;
saving information from the router including an IP address and the address space option in the memory; and
sending a message including the address space option to another router.

7. The apparatus of claim 6, wherein the received message includes a registration token option for verifying authorization of a node.

8. The apparatus of claim 6, wherein the memory includes a first parameter that stores a value of a next available IP address for assignment; and

9. The apparatus of claim 8, wherein the memory includes a second parameter that holds a total number of addresses remaining to be assigned.

10. The apparatus of claim 6, wherein the processor is further configured to request more addresses space from the router.

11. The apparatus of claim 6, wherein the router is a border router.

12. An apparatus comprising:
a non-transitory memory having instructions stored thereon for reallocating assigned IP address space; and
a processor, operably coupled to the non-transitory memory, the processor configured to perform the steps of:
receiving an update advertisement message from a border router including an address space option having a range of previously allocated address space;
checking the memory to see if an address meets the range specified in the address space option; and
sending an acknowledgment message to the border router with information about repatriating the range of previously allocated address space.

13. The apparatus of claim 12, wherein the information in the acknowledgment message is selected from the group consisting of a status code, repatriation of the entire previously allocated address space, repatriation of part of the previously allocated address space, repatriation of none of the previously allocated address space, and combinations thereof.

14. The apparatus of claim 13, further comprising:
updating the memory of available allocated address space based upon the acknowledgment message.

15. An apparatus comprising:
a non-transitory memory having instructions stored thereon for registering a node with a router; and
a processor, operably coupled to the non-transitory memory, the processor configured to perform the steps of:
receiving, from a node, a message with an address request;
assigning an address to the node using an address allocation option;
sending, to the node, a message including an address registration option and the address allocation option; and
receiving, from the node, an acknowledgment including the address registration option and the address allocation option.

16. The apparatus of claim 15, wherein the received message from the node includes a registration token option for verifying authorization of a node.

17. The apparatus of claim 15, wherein the assigning step includes checking that the registration token option matches an internal registration token option.

18. The apparatus of claim 15, wherein the received message from the node includes a multiple registration flag.

19. The apparatus of claim 15, wherein
the memory includes information of a total address and a next address, and
the processor updates the total address and the next address after the assigning step.

20. The apparatus of claim 15, wherein the processor is further configured to send a message to a second router, based upon a check of a registration token option of the node, for registering the node with the second router.
